(19) United States
(12) Patent Application Publication
(10) Pub. No.: US 2026/0017355 A1
(43) Pub. Date: Jan. 15, 2026

(54) INFORMATION PROCESSING APPARATUS, INFORMATION PROCESSING METHOD, AND RECORDING MEDIUM

(71) Applicant: NEC Corporation, Minato-ku, Tokyo (JP)

(72) Inventor: Chisato FUNAYAMA, Tokyo (JP)

(73) Assignee: NEC Corporation, Minato-ku, Tokyo (JP)

(21) Appl. No.: 18/994,702

(22) PCT Filed: Aug. 30, 2022
(86) PCT No.: PCT/JP2022/032550

§ 371 Date: Jan. 15, 2025

(51) Int. Cl. G06F 21/32; G06T 7/00; G06V 10/143; G06V 10/60; H04N 23/611; H04N 23/74

(52) U.S. Cl. CPC G06F 21/32; G06T 7/0002; G06V 10/143; G06V 10/60; H04N 23/611; H04N 23/74; G06T 2207/30168; G06T 2207/30201

(57) ABSTRACT

An information processing apparatus of this disclosure includes an obtaining unit that obtains a positional relationship between a target of biometric authentication and an imaging apparatus that images the target, ambient light information including at least one of illumination light irradiated to the target by an illumination apparatus and ambient light around the target, and brightness information at the target in an imaged image imaged by the imaging apparatus, and a control unit that controls at least one of the illumination apparatus and the imaging apparatus based on the positional relationship, the ambient light information, and the brightness information.

### TECHNICAL FIELD

This disclosure relates to an information processing apparatus, an information processing method, and a recording medium.

### BACKGROUND ART

PTL 1 describes an authentication system that authenticates a target by using a face image generated by imaging the face of the target.

### CITATION LIST

### Patent Literature

PTL 1: International Publication No. WO 2015-136938

### SUMMARY OF INVENTION

### Technical Problem

An example object of this disclosure is to improve the technique described in the above-described citation list.

### Solution to Problem

According to an example aspect of this disclosure, there is provided an information processing apparatus including an obtaining unit that obtains a positional relationship between a target of biometric authentication and an imaging apparatus that images the target, ambient light information including at least one of illumination light irradiated to the target by an illumination apparatus and ambient light around the target, and brightness information at the target in an imaged image imaged by the imaging apparatus, and a control unit that controls at least one of the illumination apparatus and the imaging apparatus based on the positional relationship, the ambient light information, and the brightness information.

According to another example aspect of this disclosure, there is provided an information processing method including the steps of obtaining a positional relationship between a target of biometric authentication and an imaging apparatus that images the target, ambient light information including at least one of illumination light irradiated to the target by an illumination apparatus and ambient light around the target, and brightness information at the target, and controlling at least one of the illumination apparatus and the imaging apparatus, based on the positional relationship, the ambient light information, and the brightness information.

According to another example aspect of this disclosure, there is provided a recording medium recording thereon a program for causing a computer to perform the steps of obtaining a positional relationship between a target of biometric authentication and an imaging apparatus that images the target, ambient light information including at least one of illumination light irradiated to the target by an illumination apparatus and ambient light around the target, and brightness information at the target in an imaged image imaged by the imaging apparatus, and controlling at least one of the illumination apparatus and the imaging apparatus, based on the positional relationship, the ambient light information, and the brightness information.

According to another example aspect of this disclosure, there is provided an information processing apparatus including an obtaining unit that obtains ambient light information representing a factor that may affect illuminance at a target of biometric authentication, and a control unit that controls, based on the ambient light information, at least one of an illumination apparatus that irradiates the target with illumination light and an imaging apparatus that images the target.

According to another example aspect of this disclosure, there is provided an information processing method including the steps of obtaining ambient light information representing a factor that may affect illuminance at a target of biometric authentication, and controlling, based on the ambient light information, at least one of an illumination apparatus that irradiates the target with illumination light and an imaging apparatus that images the target.

According to another example aspect of this disclosure, there is provided a recording medium recording thereon a program for causing a computer to perform the steps of obtaining ambient light information representing a factor that may affect illuminance at a target of biometric authentication, and controlling, based on the ambient light information, at least one of an illumination apparatus that irradiates the target with illumination light and an imaging apparatus that images the target.

### BRIEF DESCRIPTION OF DRAWINGS

FIG. 1 is a block diagram illustrating an example of the general configuration of an authentication system according to a first example embodiment.

FIG. 2 is a block diagram illustrating an example of the hardware configuration of the authentication apparatus according to the first example embodiment.

FIG. 3 is a schematic diagram for describing the authentication system according to the first example embodiment.

FIG. 4 is a front view illustrating the external appearance of the authentication apparatus according to the first example embodiment.

FIG. 5 is a perspective view for describing the internal structure of the authentication apparatus according to the first example embodiment.

FIG. 6 is a diagram illustrating an example of information stored in an ambient light information database according to the first example embodiment.

FIG. 7 is a diagram illustrating an example of information stored in a registrant information database according to the first example embodiment.

FIG. 8 is a functional block diagram illustrating the general configuration of an authentication apparatus according to the first example embodiment.

FIG. 9 is a flowchart illustrating the overview of processing performed in the authentication apparatus according to the first example embodiment.

FIG. 10 is a schematic diagram for describing a changing method of an imaging angle and an imaging range of a second camera in the authentication apparatus according to the first example embodiment.

FIG. 10 is a schematic diagram for describing the changing method of the imaging angle and the imaging range of the second camera in the authentication apparatus according to the first example embodiment.

FIG. 12 is a schematic diagram for describing an authentication system according to a second example embodiment.

FIG. 13 is a block diagram illustrating an example of the general configuration of the authentication system according to the second example embodiment.

FIG. 14 is a diagram illustrating an example of information stored in an ambient light information database according to the second example embodiment.

FIG. 15 is a diagram illustrating an example of information stored in a layout information database according to the second example embodiment.

FIG. 16 is a flowchart illustrating the overview of processing performed in an authentication apparatus according to the second example embodiment.

FIG. 17 is a flowchart illustrating the overview of processing performed in an authentication apparatus according to a third example embodiment.

FIG. 18 is a block diagram illustrating an example of the hardware configuration of an authentication apparatus according to a fourth example embodiment.

FIG. 19 is a flowchart illustrating the overview of processing performed in the authentication apparatus according to the fourth example embodiment.

FIG. 20 is a flowchart illustrating the overview of processing performed in an authentication apparatus according to a fifth example embodiment.

FIG. 21 is a flowchart illustrating the overview of processing performed in an authentication apparatus according to a sixth example embodiment.

FIG. 22 is a functional block diagram illustrating the general configuration of an authentication apparatus according to a seventh example embodiment.

FIG. 23 is a flowchart illustrating the overview of processing performed in the authentication apparatus according to the seventh example embodiment.

FIG. 24 is a flowchart illustrating the overview of processing performed in the authentication apparatus according to the seventh example embodiment.

FIG. 25 is a flowchart illustrating the overview of processing performed in the authentication apparatus according to the seventh example embodiment.

FIG. 26 is a functional block diagram illustrating the general configuration of an authentication apparatus according to an eighth example embodiment.

FIG. 27 is a schematic diagram for describing a neural network used for learning processing according to the eighth example embodiment.

FIG. 28 is a flowchart illustrating the overview of processing performed in the authentication apparatus according to the eighth example embodiment.

FIG. 29 is a flowchart illustrating the overview of the processing performed in the authentication apparatus according to the eighth example embodiment.

FIG. 30 is a flowchart illustrating the overview of processing performed in an authentication apparatus according to a ninth example embodiment.

FIG. 31 is a functional block diagram illustrating the general configuration of an information processing apparatus according to a tenth example embodiment.

FIG. 32 is a functional block diagram illustrating the general configuration of an information processing apparatus according to an eleventh example embodiment.

FIG. 33 is a schematic diagram for describing a changing method of an imaging angle and an imaging range of a second camera in an authentication apparatus according to a variant example embodiment.

FIG. 34 is a schematic diagram for describing the changing method of the imaging angle and the imaging range of the second camera in the authentication apparatus according to the variant example embodiment.

FIG. 35 is a diagram illustrating an example of the positional relationship among an imaging apparatus, an illumination apparatus, and an authentication subject in the variant example embodiment.

### DESCRIPTION OF EMBODIMENTS

Hereinafter, example embodiments of this disclosure will be described with reference to the drawings. In the drawings, the same numerals are given to the same elements or corresponding elements, and a description thereof may be omitted or simplified.

### First Example Embodiment

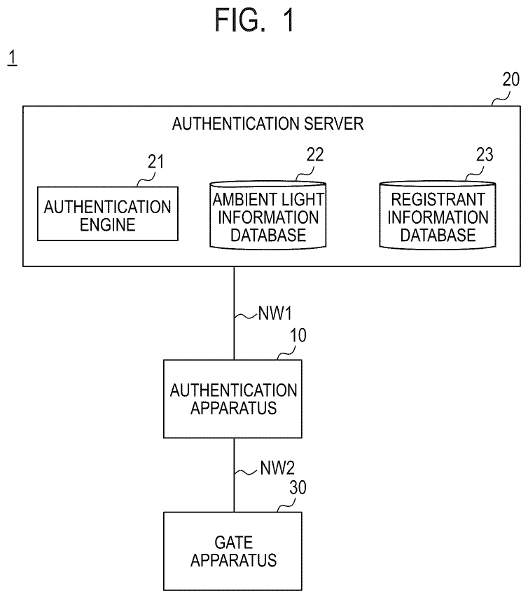

FIG. 1 is a block diagram illustrating an example of the general configuration of an authentication system 1 according to a first example embodiment. The authentication system 1 is constituted by an authentication apparatus 10, an authentication server 20, and a gate apparatus 30. Each apparatus is connected to networks NW1 and NW2, such as a LAN (Local Area Network) and the Internet.

The authentication system 1 performs biometric authentication by obtaining biological information of a person to be authenticated (hereinafter referred to as an “authentication target”) and comparing the obtained biological information with registered biological information that is registered in advance.

Although the phrase “biological information” in the first example embodiment shall mean a face image and a feature value extracted from the face image, the biological information is not limited to the face image and the face feature value. That is, the authentication system 1 may perform biometric authentication by using, as the biological information of the authentication target, a biometric image other than a face image (an iris image, a fingerprint image, a palm print image, a vein image, a gait image, an auricular image, or the like) and a feature value.

The authentication system 1 may be applied to, for example, personal identification for arrival and departure at an airport, personal identification in an administrative agency, personal identification for entrance and exit in a factory/office, personal identification for entrance and exit at an event venue, and the like. In addition, the authentication system 1 is also applicable to payments based on biometric authentication. The authentication system 1 is applicable to authentication in various technical fields.

The authentication apparatus 10 is a computer that images the authentication target who is present in an authentication area, and outputs a biometric image thereof to the authentication server 20. In the first example embodiment, the “authentication area” means the three-dimensional space in a predetermined range located in front of the authentication apparatus 10. In addition, a “biometric image” in the first example embodiment is a face image.

In addition, the authentication apparatus 10 controls at least one of a second camera 107B and a illumination apparatus 108, which will be described later, based on information (hereinafter referred to as “ambient light information”) that defines in advance the ambient light irradiates from various light sources, such as the sun, to the authentication target, and images the authentication target. As specific examples of the ambient light information, the illuminance, irradiation direction, and the like of the ambient light can be listed. In the first example embodiment, unless otherwise specified, the ambient light shall include illumination light.

The authentication server 20 is a computer that performs biometric authentication. The authentication server 20 includes an authentication engine 21, an ambient light information database 22, and a registrant information database 23. The authentication engine 21 performs comparison processing of a biometric image (or a feature value) of the authentication target imaged by the authentication apparatus 10 with registered biometric images (or feature values) of registrants registered in advance in the registrant information database 23 and performs biometric authentication of the authentication target based on the comparison result.

The ambient light information database 22 stores ambient light information for each point at which biometric authentication is performed. The registrant information database 23 stores information of registrants who are allowed to pass the gate apparatus 30.

The gate apparatus 30 is a passage control apparatus that opens and closes a gate (not illustrated) based on control information from the authentication apparatus 10, and controls passing of persons. When the authentication apparatus 10 succeeds in authentication of a person, the gate apparatus 30 transitions from a closed state during standby to block passage of the person to an open state that allows passage of the persons. The type of the gate is not particularly limited, and is, for example, a flapper gate in which a flapper provided from one side or both sides of an aisle is opened and closed, a turnstile gate in which three bars are rotated, or the like.

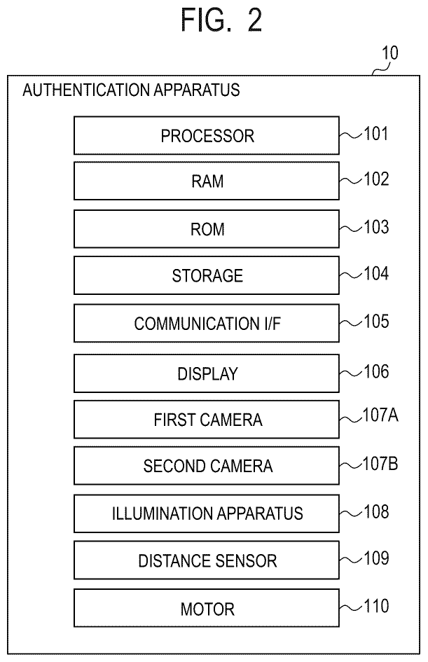

FIG. 2 is a block diagram illustrating an example of the hardware configuration of the authentication apparatus 10 according to the first example embodiment. The authentication apparatus 10 includes, as a computer that performs arithmetic operations, control, and storage, a processor 101, a RAM (Random Access Memory) 102, a ROM (Read Only Memory) 103, a storage 104, a communication I/F (Interface) 105, a display 106, a first camera 107A, the second camera 107B, the illumination apparatus 108, a distance sensors 109, and a motor 110. Each apparatus is connected to each other via a bus, a wire, a driving apparatus, and the like, which are not illustrated.

The processor 101 has a function of performing predetermined arithmetic operations according to programs stored in the ROM 103, the storage 104, and the like, and controlling each unit of the authentication apparatus 10. In addition, a CPU (Central Processing Unit), a GPU (Graphics Processing Unit), an FPGA (Field Programmable Gate Array), a DSP (Digital Signal Processor), an ASIC (Application Specific Integrated Circuit), or the like is used as the processor 101. In addition, one of the above-described examples may be used, or a plurality of them may be used in parallel.

The RAM 102 is constituted by a volatile storage medium and provides a temporary memory area required for the operation of the processor 101. The RAM 102 may be, for example, a D-RAM (Dynamic RAM). The ROM 103 is constituted by a non-volatile storage medium, and stores required information such as a program and the like that are used for the operation of the authentication apparatus 10. The ROM 103 may be, for example, a P-ROM (Programmable ROM).

The storage 104 is constituted by a non-volatile storage medium, and performs storing of data, storing of a program for the operation of the authentication apparatus 10, and the like. The storage 104 is constituted by, for example, an HDD (Hard Disk Drive) or an SSD (Solid State Drive).

The communication I/F105 is a communication interface based on the standard such as Ethernet (registered trademark), Wi-Fi (registered trademark), 4G, 5G, or the like, and is a module for performing communication with other apparatuses.

The processor 101 loads the programs stored in the ROM 103, the storage 104, and the like into the RAM 102 to execute the programs.

The display 106 is display apparatus that displays a moving image, a still image, characters, and the like. The display 106 displays, for example, guidance information and authentication results regarding authentication. A liquid crystal display, an OLED (Organic Light Emitting Diode) display, or the like is used as the display 106.

The first camera 107A is an imaging apparatus that images an entire authentication area. The first camera 107A includes a light receiving element configured to be sensitive to infrared light. A digital camera using a CMOS (Complementary Metal Oxide Semiconductor) image sensor, a CCD (Charge Coupled Device) image sensor, or the like is used as the first camera 107A, so as to be suitable for image processing in the authentication apparatus 10.

The second camera 107B is imaging apparatus that images a predetermined body part of the authentication target. The second camera 107B includes a light receiving element configured to be sensitive to infrared light. A digital camera using a CMOS image sensor, a CCD image sensor, or the like is used as the second camera 107B. The first camera 107A and the second camera 107B have mutually different imaging targets, resolutions, and the like. The imaging range of the first camera 107A may include the imaging range of the second camera 107B.

In addition, although the first camera 107A and the second camera 107B are infrared cameras in the present example embodiment, the combination pattern of the first camera 107A and the second camera 107B is not limited to this. For example, the first camera 107A may be a visible light camera, and the second camera 107B may be an infrared camera. In addition, the first camera 107A may be an infrared camera, and the second camera 107B may be a visible light camera. Similarly, both the first camera 107A and the second camera 107B may be visible light cameras.

The illumination apparatus 108 includes a light emitting element that emits infrared light, such as an infrared light LED. The wavelength of the infrared light irradiated from the illumination apparatus 108 may be, for example, in a near-infrared area of about 800 nm. The timing of the irradiation of the illumination light in the illumination apparatus 108 is synchronized with the timing of the imaging in the first camera 107A and the second camera 107B. However, the timing of the irradiation of the illumination light in the illumination apparatus 108 may not be synchronized with the timing of the imaging in each of the cameras.

In addition, in the present example embodiment, although the illumination apparatus 108 is an irradiation apparatus of infrared light provided corresponding to the second camera 107B, which is an infrared camera, the illumination apparatus 108 is not limited to this. For example, the illumination apparatus 108 may be an irradiation apparatus of visible light. In addition, a plurality of illumination apparatuses 108 may be provided to irradiate infrared light and visible light, respectively.

The distance sensor 109 is a measuring apparatus that measures the distance from the authentication apparatus 10 to the authentication target. The distance sensor 109 may be able to optically measure the distance from the authentication apparatus 10 to the authentication target. As an example of the distance sensor 109 that can optically measure the distance, a TOF (Time Of Flight) sensor, a triangulation sensor, a LiDAR (Light Detection and Ranging), or the like can be listed. In addition, as the distance sensor 109, a proximity sensor that detects proximity of a target in a non-contact manner can also be used.

The motor 110 is a driving apparatus that drives an object connected to a rotation axis (not illustrated). In the first example embodiment, the second camera 107B is connected to the rotation axis of the motor 110. Note that the second camera 107B may not be directly connected to the rotation axis of the motor 110. For example, the second camera 107B may be indirectly connected to the rotation axis via a gear, a belt, or the like, and may be driven by the motor 110.

Note that the hardware configuration illustrated in FIG. 2 is an example, and apparatuses other than these may be added, or a part of the apparatuses may not be provided. In addition, a part of the apparatuses may be replaced with other apparatuses that have similar functions. In addition, a part of the functions of the first example embodiment may be provided by other apparatuses via a network, or the functions of the first example embodiment may be realized by being distributed among a plurality of apparatuses. The illustrated hardware configuration can be appropriately changed.

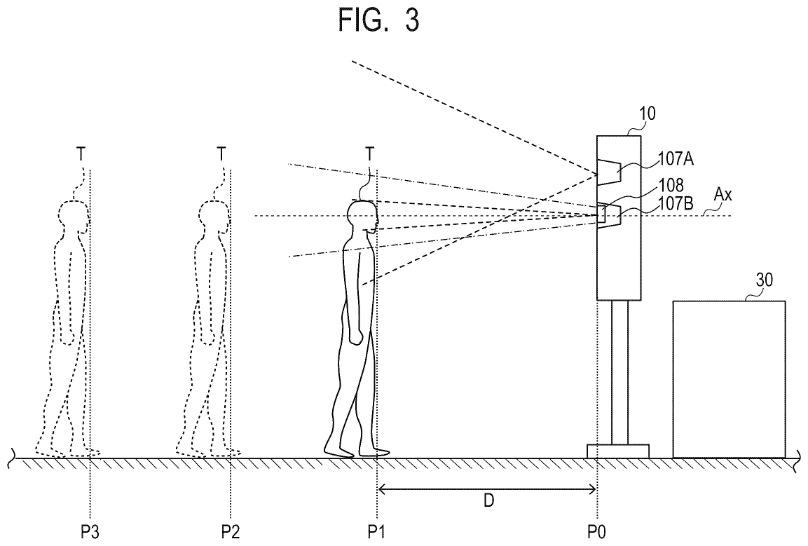

FIG. 3 is a schematic diagram for describing the authentication system 1 according to the first example embodiment. As illustrated in FIG. 3, the authentication system 1 is a walk-through biometric authentication system that images the authentication target who moves toward the authentication apparatus 10 in the authentication area by using the first camera 107A and the second camera 107B. Note I that, although FIG. 3 illustrates a case where biometric authentication for the authentication target is performed three times in the order of points P3, P2, and P1, the points at which biometric authentication is performed are not limited to these. A distance D is the distance from a position PO of the authentication apparatus 10 to the point P1 at which an authentication target T is standing.

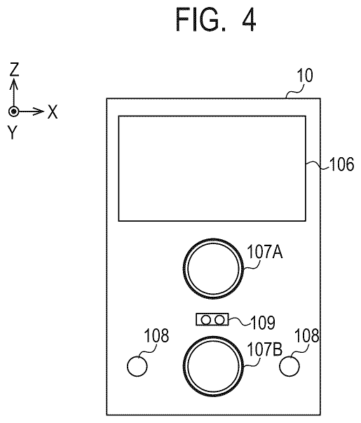

FIG. 4 is a front view illustrating the external appearance of the authentication apparatus 10 according to the first example embodiment. FIG. 4 describes the positional relationship between components constituting the authentication apparatus 10, by using a three-dimensional coordinate system constituted by an X axis, a Y axis, and a Z axis that are orthogonal to each other. The X axis and the Y axis are axes in a horizontal plane. The X axis and the Y axis are orthogonal to each other. The Z axis is an axis that is orthogonal to the horizontal plane.

In FIG. 4, the display 106, the first camera 107A, the distance sensor 109, and the second camera 107B are arranged sequentially from the top along a center line of the authentication apparatus 10. In addition, a pair of lighting apparatuses 108 are arranged on both sides of the second camera 107B.

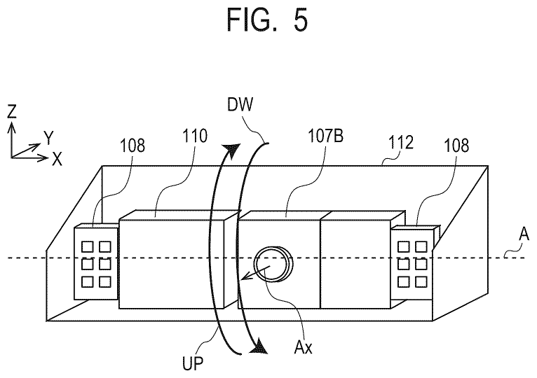

FIG. 5 is a perspective view for describing the internal structure of the authentication apparatus 10 according to the first example embodiment. As illustrated in FIG. 5, the second camera 107B and the illumination apparatuses 108 are arranged in a case 112 together with the motor 110. The first camera 107A has a wider angle of view than the second camera 107B. The first camera 107A is not provided in the case 112 in order to maintain the imaging angle constant. The second camera 107B and the illumination apparatuses 108 are connected to a rotation axis A of the motor 110. Therefore, the second camera 107B and the illumination apparatuses 108 are rotated with the rotation axis A. An optical axis Ax of the second camera 107B is changed up and down by the rotation around the rotation axis A. The imaging angle of the second camera 107B in the first example embodiment means the angle of the optical axis Ax with respect to the horizontal plane.

When the motor 110 is driven, the second camera 107B is rotated around the rotation axis A in the direction of an arrow UP or an arrow DW. When the second camera 107B is rotated in the direction of the arrow UP, the imaging range of the second camera 107B is moved upward. Conversely, when the second camera 107B is rotated in the direction of the arrow DW, the imaging range of the second camera 107B is moved downward.

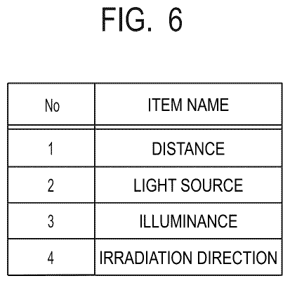

FIG. 6 is a diagram illustrating an example of information stored in the ambient light information database 22 according to the first example embodiment. The ambient light information database 22 includes data items such as the distance from the authentication apparatus 10 to a light receiving point of the ambient light, a light source of the ambient light, the illuminance of the ambient light, and the irradiation direction of the ambient light. The light source is the sun, the illumination apparatus 108, or an illumination apparatus other than the illumination apparatus 108 of the authentication apparatus 10. By referring to the ambient light information based on the distance, for example, it can be found at what illuminance the authentication target is irradiated with each of the sunlight and light the illumination from the illumination apparatus 108 at a point that is two meters distance in front of the authentication apparatus 10. In addition, it can also be found how the illuminance of the illumination light is changed according to the distance. The ambient light information is generated in advance based on, for example, a measured value actually measured by using an illuminance sensor in the authentication area, and a predicted value calculated by simulation on a computer.

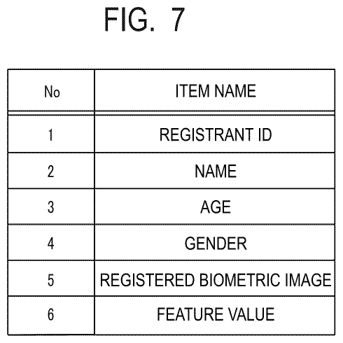

FIG. 7 is a diagram illustrating an example of information stored in the registrant information database 23 according to the first example embodiment. The registrant information database 23 includes data items such as registrant ID that identifies a registrant, name, age, gender, registered biometric image, and feature value.

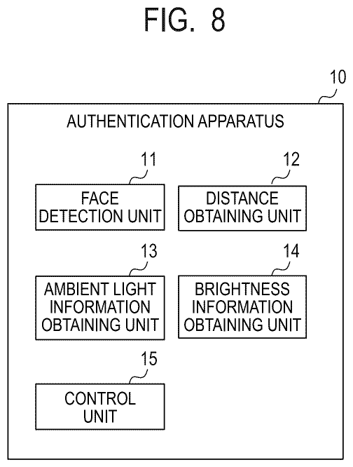

FIG. 8 is a functional block diagram illustrating the general configuration of the authentication apparatus 10 according to the first example embodiment. The authentication apparatus 10 includes a face detection unit 11, a distance obtaining unit 12, an ambient light information obtaining unit 13, a brightness information obtaining unit 14, and a control unit 15.

The face detection unit 11 analyzes an imaged image of the authentication area imaged by the first camera 107A and detects the face of the authentication target from the imaged image. In the first example embodiment, the face detection unit 11 detects the position and size of the face of the authentication target from the imaged image.

The distance obtaining unit 12 obtains the distance from the authentication apparatus 10 to the authentication target based on a detection signal of the distance sensor 109. In the first example embodiment, since the second camera 107B and the illumination apparatuses 108 are provided in a housing of the authentication apparatus 10, the positional relationship among the second camera 107B, the illumination apparatuses 108, and the authentication target can be specified by the distance from the authentication apparatus 10 to the target. That is, the positional relationship among second the camera 107B, the illumination the authentication apparatuses 108, and target in the first embodiment corresponds to the positional relationship between the authentication apparatus 10 and the authentication target.

In addition, in the first example embodiment, the information such as the illuminance and irradiation direction of the ambient light is associated in advance with the distance, that is, the positional relationship between the authentication apparatus 10 (camera) and the authentication target in the ambient light information database 22. Therefore, the ambient light information obtaining unit 13 refers to the ambient light information database 22 based on the distance from the authentication apparatus 10 to the authentication target and obtains the ambient light information corresponding to the distance. The ambient light information may be different between, for example, a first point that is 3 meters away from the authentication apparatus 10 and a second point that is 2 meters away from the authentication apparatus 10.

The brightness information obtaining unit 14 analyzes the imaged image of the authentication area imaged by the first camera 107A or the biometric image of the authentication target imaged by the second camera 107B and obtains the brightness information for a predetermined body part of the authentication target in the image. As an example of the body part for which the brightness information is obtained, the face, eyes, or the like of the authentication target can be listed. In addition, the brightness of the body part may be, for example, an average brightness value in a pixel group of a skin area of the face.

The control unit 15 controls at least one of the second camera 107B and the illumination apparatuses 108, based on the positional relationship between the second camera 107B (the authentication apparatus 10) and the authentication target, the ambient light information including at least one of the illumination light irradiated to the authentication target by the illumination apparatus 108 and the ambient light around the authentication target, and the brightness information of the authentication target in the imaged image imaged by the second camera 107B. The control unit 15 can, for example, determine the color of the skin of the authentication target based on the brightness information, and adjust the illuminance and wavelength of the illumination light irradiated from the second camera 107B, or the imaging condition of the second camera 107B. Similarly, the control unit 15 may adjust the illuminance and wavelength of the illumination light based on the color of the eyes of the authentication target. Accordingly, the brightness of the biometric image imaged by the second camera 107B falls within a predetermined range compatible with the biometric authentication. By performing biometric authentication using the biometric image imaged with appropriate brightness, it is possible to improve the authentication accuracy in biometric authentication.

The processor 101 loads the programs stored in the ROM 103, the storage 104, and the like into the RAM to execute the programs. Accordingly, the processor 101 realizes the functions of the face detection unit 11, the distance obtaining unit 12, the ambient light information obtaining unit 13, the brightness information obtaining unit 14, the control unit 15, and the like, which have been described above.

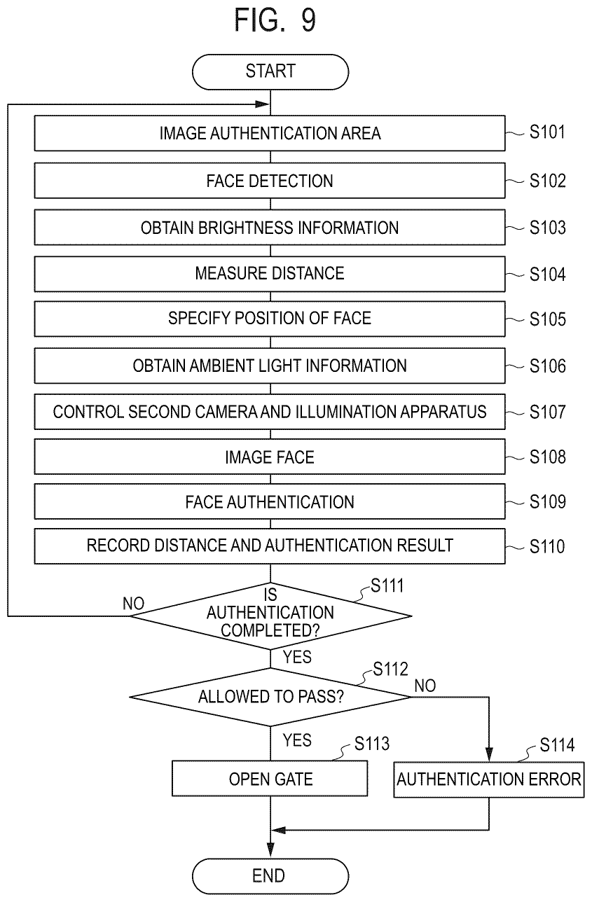

FIG. 9 is a flowchart illustrating the overview of processing performed in the authentication apparatus 10 according to the first example embodiment.

In step S101, the authentication apparatus 10 obtains an imaged image of the entire authentication area by imaging the authentication area in front of the apparatus by the first camera 107A.

In step S102, the authentication apparatus 10 performs face detection of a person on the imaged image. Specifically, the authentication apparatus 10 detects an area that matches the shape pattern of the face of the person from the imaged image. When the authentication apparatus 10 detects the face of the person who is the authentication target, the processing transitions to step S103.

In step S103, the authentication apparatus 10 analyzes the imaged image to obtain the brightness information of a face area of the authentication target. Accordingly, the authentication apparatus 10 can obtain the skin color of the face area of the authentication target.

In step S104, the authentication apparatus 10 measures the horizontal distance from the authentication apparatus 10 to the authentication target based on the detection signal from the distance sensor 109.

In step S105, the authentication apparatus 10 identifies the position of the face in the three-dimensional space, based on the coordinates of the face in the imaged image and the distance measured in step S104. By identifying the position of the actual face, it becomes possible to align the pointing directions of the second camera 107B and the illumination apparatuses 108 with the authentication target. By aligning the pointing directions of the second camera 107B and the illumination apparatuses 108 with the authentication target, a biometric image more appropriate for authentication can be obtained.

In step S106, the authentication apparatus 10 refers to the ambient light information database 22 based on the distance measured in step S104 and obtains the ambient light information for the distance. For example, when the authentication target is at a distance 2 meters away from the authentication apparatus 10, the ambient light information corresponding to two meters is obtained.

In step S107, the authentication apparatus 10 controls the second camera 107B and the illumination apparatuses 108 based on the ambient light information and the brightness information. Specifically, the authentication apparatus 10 controls the exposing condition, the gain, the timing of imaging, the imaging angle, and the like of the second camera 107B. In addition, the authentication apparatus 10 controls the illuminance, the wavelength, the irradiation direction, the timing of irradiation, and the like of the illumination light irradiated from the illumination apparatus 108.

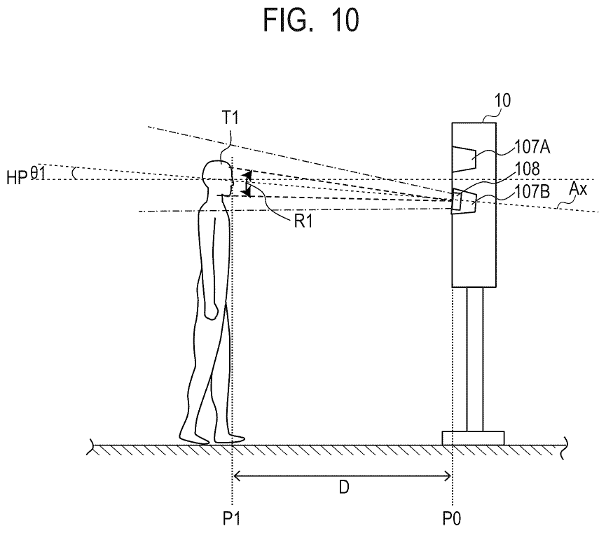

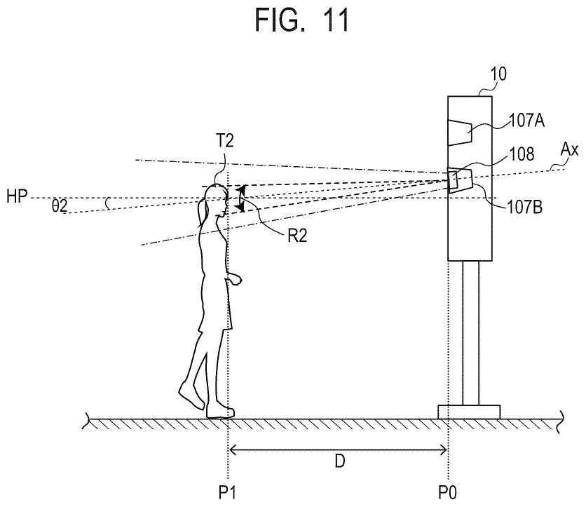

FIG. 10 and FIG. 11 are schematic diagrams for describing the imaging angle and the imaging range of the second camera 107B according to the first example embodiment. In FIG. 10, the position of the face of an authentication target T1 is higher than the center position of the second camera 107B in a vertical direction. Therefore, in the second camera 107B, the imaging angle is set so that the optical axis Ax of the second camera 107B is directed upward from the horizontal. An imaging range R1 of the second camera 107B in FIG. 10 includes the face of the authentication target T1.

In FIG. 11, the height of an authentication target T2 is lower than the height of the authentication target T1. In addition, the position of the face of the authentication target T2 is lower than the center position of the second camera 107B in the vertical direction. Therefore, the imaging angle is set so that the optical axis Ax of the second camera 107B is directed downward from the horizontal. Therefore, an imaging range R2 of the second camera 107B in FIG. 11 is moved lower in the vertical direction than the imaging range R1 illustrated in FIG. 11. The imaging range R2 includes the face of the authentication target T2.

In step S108, the authentication apparatus 10 images the face of the authentication target by the second camera 107B and generates a face image.

In step S109, the authentication apparatus 10 transmits the face image generated in step S108 to the authentication engine 21 and causes the authentication engine 21 to perform face recognition. When the authentication engine 21 compares the received face image with registered face images of registrants registered in the registrant information database 23 to perform the face recognition, the authentication engine 21 transmits an authentication result to the authentication apparatus 10.

In step S110, the authentication apparatus 10 records, in storage apparatuses such as the RAM 102 and the storage 104, the distance at the time when the face image is imaged and the authentication result received from the authentication engine 21 in association with an imaging time. Accordingly, the time series data of the distance of the authentication target who moves in the authentication area and the authentication result is obtained.

In step S111, the authentication apparatus 10 determines whether or not to complete the authentication of the authentication target. For example, the authentication apparatus 10 can determine whether or not to complete the authentication, based on whether or not the number of times of the authentication has reached a predetermined number, or whether or not the authentication has been successful at least once.

Here, when the authentication apparatus 10 determines to complete the authentication of the authentication target (step S111: YES), the processing transitions to step S112. On the other hand, when the authentication apparatus 10 determines not to complete the authentication of the authentication target (step S111: NO), the processing returns to step S101. Accordingly, the authenticating processing of the authentication target who toward the moves authentication apparatus 10 in the authentication area is repeatedly performed.

In step S112, the authentication apparatus 10 determines whether or not to allow the authentication target to pass the gate apparatus 30, based on the authentication result recorded in the storage apparatus for the authentication target.

Here, when the authentication apparatus 10 determines to allow the authentication target to pass the gate apparatus 30 (step S112: YES), the authentication apparatus 10 opens a gate (step S113) and ends the processing.

On the other hand, when the authentication apparatus 10 determines not to allow the authentication target to pass the gate apparatus 30 (step S112: NO), the authentication apparatus 10 causes the display 106 to display information of an authentication error (step S114) and ends the processing.

In the conventional authentication system as illustrated in Patent Literature 1, the influence of the ambient light at a point at which a biometric image is imaged has not been considered. Therefore, there have been cases where the imaged biometric image is not suitable for biometric authentication. On the other hand, with the authentication system 1 according to the first embodiment, each of the second camera 107B and the illumination apparatuses 108 can be controlled based on the ambient light information defined in advance for each distance, and the brightness information obtained from the imaged image. Accordingly, the condition at the time of imaging of the face of the authentication target by the second camera 107B can be appropriately adjusted, and a face image compatible with the face recognition performed in the authentication engine 21 can be obtained.

### Second Example Embodiment

Hereinafter, the authentication system 1 according to a second example embodiment will be described. Hereinafter, a description will be mainly given of differences from the first example embodiment, and a description will be omitted or simplified for common parts.

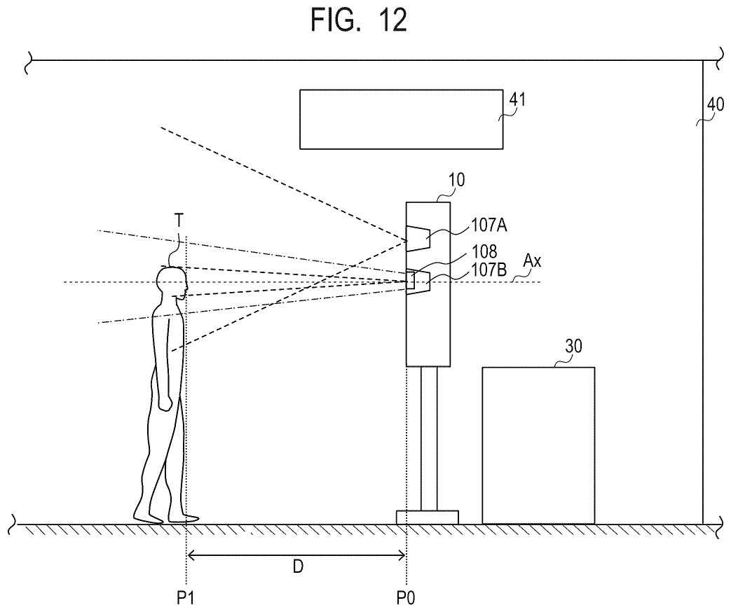

FIG. 12 is a schematic diagram for describing the authentication system 1 according to the second example embodiment. FIG. 12 illustrates that face recognition is performed for the authentication target T who is standing at the point P1. In addition, an outer wall 40 located on the back side of the authentication apparatus 10 is provided with a window 41 through which the ambient light can enter at a position higher than the authentication apparatus 10.

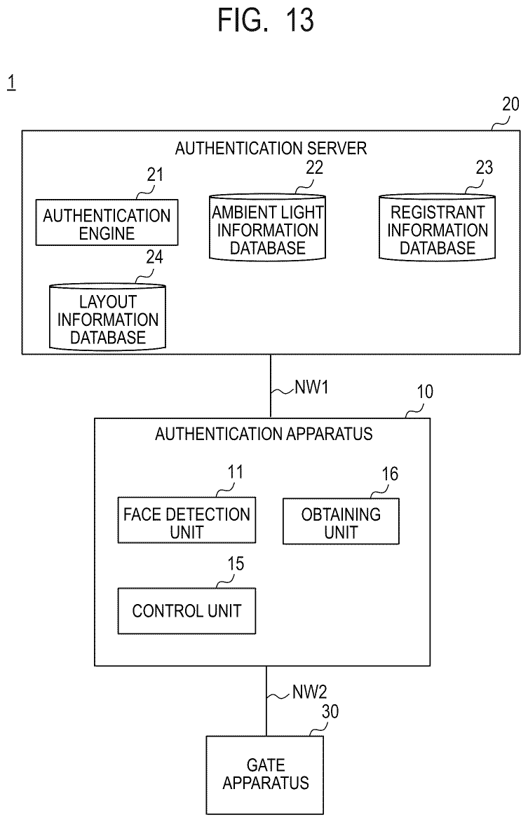

FIG. 13 is a block diagram illustrating an example of the general configuration of the authentication system 1 according to the second example embodiment. Unlike the case of the first example embodiment, the authentication apparatus 10 includes the face detection unit 11, an obtaining unit 16, and the control unit 15. In addition, the authentication server 20 further includes a layout information database 24.

The obtaining unit 16 obtains ambient light information representing a factor that may affect the illuminance at the target of biometric authentication. In the second example embodiment, the obtaining unit 16 obtains the ambient light information including the date and time at which the authentication target is imaged, and the layout information of a facility in which the authentication area is provided. The layout information includes the optical properties, shapes, sizes, and arrangement of structures provided in the facility. The layout information is defined based on coordinates in the three-dimensional space.

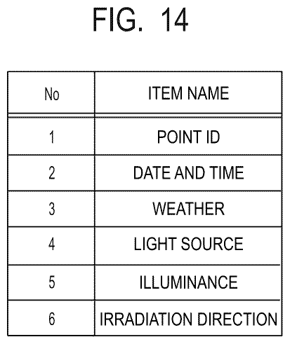

FIG. 14 is a diagram illustrating an example of information stored in the ambient light information database 22 according to the second example embodiment. The ambient light information database 22 includes data items such as point ID, date and time, weather, light source, illuminance, and irradiation direction. For example, when the date and time is 14:00 on August 1, the ambient light information including the illuminance and irradiation direction of the sunlight irradiated at the point P1, which is the authentication area, can be obtained from the ambient light information database 22 by using the date and time as a key. The illuminance and irradiation direction of the ambient light are different depending on the type of light source, the date and time of imaging, and weather. In the second example embodiment, it is assumed that the information such as the illuminance and irradiation direction of the ambient light is not associated with the distance (the positional relationship) in the ambient light information database 22.

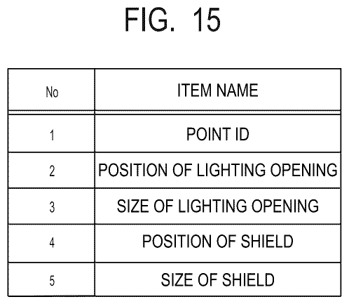

FIG. 15 is a diagram illustrating an example of information stored in the layout information database 24 according to the second example embodiment. The layout information database 24 includes data items such as point ID, position of lighting opening, size of lighting opening, position of shield, and size of shield. The ambient light information of the ambient light irradiated on the authentication area varies depending on the positions and sizes of a lighting opening and a shield in the facility in which the authentication area is provided. Therefore, highly accurate ambient light information regarding the illuminance of the ambient light in the authentication area can be obtained by combining the ambient light information and the layout information.

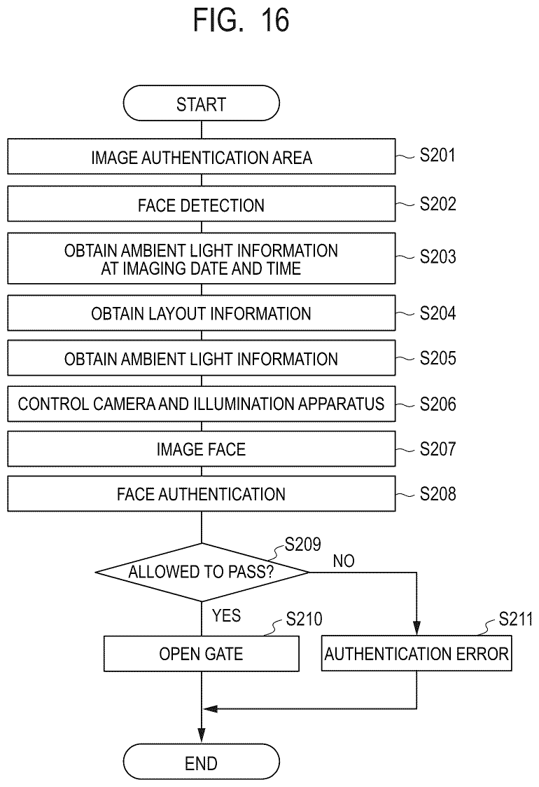

FIG. 16 is a flowchart illustrating the overview of processing performed in the authentication apparatus 10 according to the second example embodiment.

In step S201, the authentication apparatus 10 obtains an imaged image of the entire authentication area by imaging the authentication area in front of the apparatus by the first camera 107A.

In step S202, the authentication apparatus 10 performs face detection processing of the authentication target on the imaged image. When the authentication apparatus 10 detects the face of the authentication target, the processing transitions to step S203.

In step S203, the authentication apparatus 10 refers to the ambient light information database 22 based on the imaging date and time and obtains the ambient light information. Note that, since the condition of the sunlight is different between when it is sunny and when it is rainy even on the same date and time, the information of the weather may be further obtained from an external system based on the position information of a point at which imaging is performed and the imaging date and time (current time), and thereafter the ambient light information database 22 may be referred to based on the imaging date and time and the weather. A more appropriate biometric image can be obtained by considering the position of the point at which imaging is performed, the date and time, the weather, and the like.

In step S204, the authentication apparatus 10 obtains the layout information from the layout information database 24 by using the point ID corresponding to the authentication area in the authentication apparatus 10 as a key.

In step S205, the authentication apparatus 10 obtains the final ambient light information in the authentication area based on the ambient light information and the layout information.

In step S206, the authentication apparatus 10 controls each of the second camera 107B and the illumination apparatuses 108 based on the obtained ambient light information. Specifically, the authentication apparatus 10 controls the exposing condition, the gain, the timing of imaging, the imaging angle, and the like of the second camera 107B. In addition, the authentication apparatus 10 controls the illuminance, the wavelength, the irradiation direction, the timing of irradiation, and the like of the illumination light irradiated from the illumination apparatus 108.

In step S207, the authentication apparatus 10 images the face of the authentication target by the second camera 107B and generates a face image.

In step S208, the authentication apparatus 10 transmits the face image generated in step S207 to the authentication engine 21 and causes the authentication engine 21 to perform face recognition. When the authentication engine 21 compares the received face image with the registered face images of the registrants registered in the registrant information database 23 to perform the face recognition, the authentication engine 21 transmits an authentication result to the authentication apparatus 10.

In step S209, the authentication apparatus 10 determines whether or not to allow the authentication target to pass the gate apparatus 30, based on the authentication result received from the authentication engine 21.

Here, when the authentication apparatus 10 determines to allow the authentication target to pass the gate apparatus 30 (step S209: YES), the authentication apparatus 10 opens the gate (step S210) and ends the processing.

On the other hand, when the authentication apparatus 10 determines not to allow the authentication target to pass the gate apparatus 30 (step S209: NO), the authentication apparatus 10 causes the display 106 to display the information of an authentication error (step S211) and ends the processing.

As described above, with the authentication system 1 according to the second example embodiment, the ambient light information can be obtained based on the imaging date and time of the biometric image, and the layout information of the facility in which the biometric authentication is performed, and each of the second camera 107B and the illumination apparatus 108 can be controlled. Accordingly, the condition at the time of imaging of the face of the authentication target by the second camera 107B can be appropriately adjusted, and a face image compatible with the face recognition performed in the authentication engine 21 can be obtained. For example, when the imaging date and time is 15:00, and an authentication point is irradiated with the sunlight with an irradiation angle θ from the window 41 of the facility, each of the second camera 107B and the illumination apparatuses 108 can be controlled so as to suppress the influence of the sunlight based on the positional relationship between the window 41 and the authentication point.

### Third Example Embodiment

Hereinafter, the authentication system 1 according to a third example embodiment will be described. Hereinafter, a description will be mainly given of differences from the first example embodiment, and a description will be omitted or simplified for common parts.

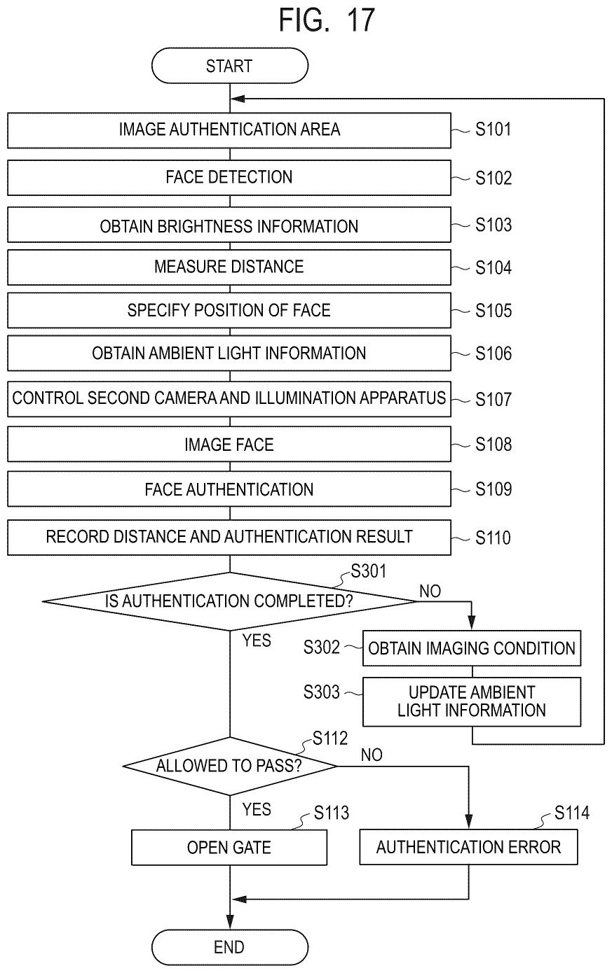

FIG. 17 is a flowchart illustrating the overview of processing performed in an authentication apparatus according to the third example embodiment. In FIG. 17, although the processing in steps S101 to S110 and steps S112 to S114 is similar to that of the first example embodiment, processing in step S301 to step S303 is different from that of the first example embodiment.

When the processing in step S110 is completed, the processing transitions to step S301. In step S301, the authentication apparatus 10 determines whether or not to complete the authentication of the authentication target.

Here, when the authentication apparatus 10 determines to complete the authentication of the authentication target (step S301: YES), the processing transitions to step S112. On the other hand, when the authentication apparatus 10 determines not to complete the authentication of the authentication target (step S301: NO), the processing transitions to step S302.

In step S302, the authentication apparatus 10 obtains the imaging condition of the second camera 107B at the time of imaging of the face of the authentication target.

n step S303, the authentication apparatus 10 updates the ambient light information in the ambient light information database 22 based on the imaging condition, the positional relationship, and the authentication result. example, when the For illuminance of the ambient light at the time of imaging of the face is different from expected illuminance, and the authentication has failed, the authentication apparatus 10 estimates the actual illuminance of the ambient light by analyzing the imaged image. Then, the authentication apparatus 10 updates the ambient light information database 22 by using the estimated ambient light information. The authentication apparatus 10 can perform control of the second camera 107B and the illumination apparatuses 108 in detail and accurately by considering the combination of the imaging condition, the positional relationship, and the authentication result. When the processing in step S303 ends, the processing returns to step S101.

As described above, with the authentication system 1 according to the first example embodiment, since the ambient light information in the ambient light information database 22 can be flexibly changed based on the imaging condition and the authentication result, the accuracy of the biometric authentication performed thereafter can be improved.

### Fourth Example Embodiment

Hereinafter, the authentication system 1 according to a fourth example embodiment will be described. Hereinafter, a description will be mainly given of differences from the first example embodiment, and a description will be omitted or simplified for common parts.

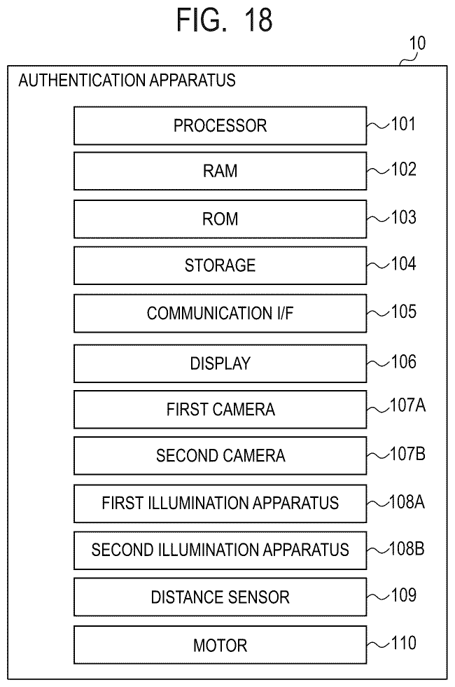

FIG. 18 is a block diagram illustrating an example of the hardware configuration of the authentication apparatus 10 according to the fourth example embodiment. In FIG. 18, unlike the case of FIG. 2, it is illustrated that the authentication apparatus 10 includes a first illumination apparatus 108A and a second illumination apparatus 108B. The first illumination apparatus 108A is an illumination apparatus that irradiates infrared light toward the face of the authentication target when imaging the face of the authentication target. The second illumination apparatus 108B is an illumination apparatus that irradiates infrared light toward the eyes of the authentication target when imaging the irises of the authentication target.

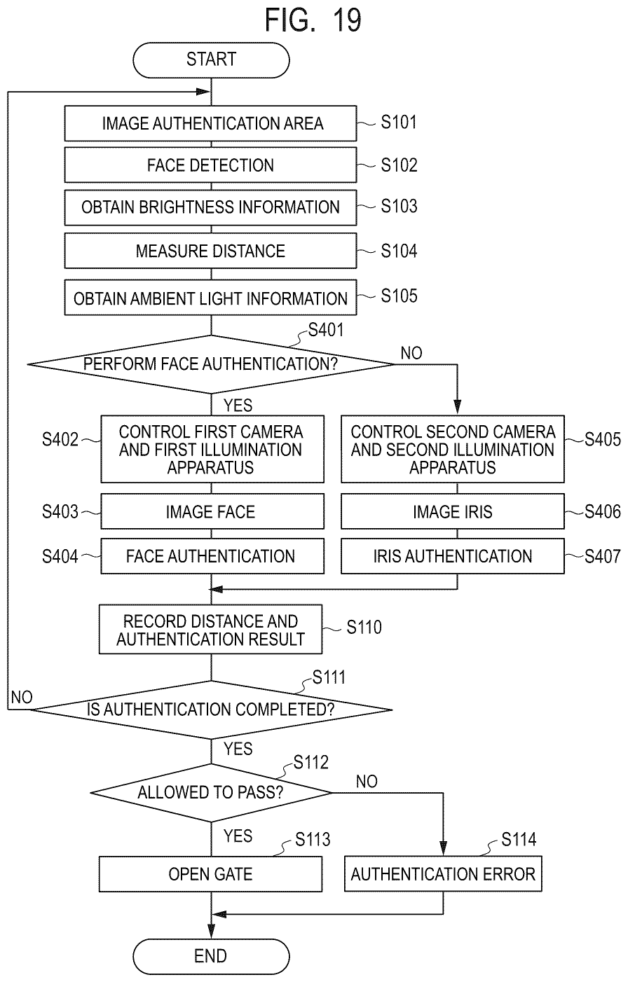

FIG. 19 is a flowchart illustrating the overview of processing performed in the authentication apparatus 10 according to the fourth example embodiment. Although the processing in steps S101 to S105 and steps S110 to S114 of FIG. 19 is similar to that of the first example embodiment, processing in step S401 to step S407 is different from that of the first embodiment.

When the processing in step S105 is completed, the processing transitions to step S401. In step S401, the authentication apparatus 10 determines whether or not to perform the face recognition for the authentication target.

Here, when the authentication apparatus 10 determines to perform the face recognition for the authentication target (step S401: YES), the processing transitions to step S402. On the other hand, when it is determined to perform iris authentication without performing the face recognition for the authentication target (step S401: NO), the processing transitions to step S405.

In step S402, the authentication apparatus 10 controls the first camera 107A and the first illumination apparatus 108A based on the ambient light information and the brightness information.

In step S403, the authentication apparatus 10 images the face of the authentication target by the first camera 107A and generates a face image.

In step S404, the authentication apparatus 10 transmits the face image generated in step S403 to the authentication engine 21 and causes the authentication engine 21 to perform the face recognition. When the authentication engine 21 compares the received face image with the registered face images of the registrants registered in the registrant information database 23 to perform the face recognition, the authentication engine 21 transmits an authentication result to the authentication apparatus 10. Thereafter, the processing transitions to step S110.

In step S405, the authentication apparatus 10 controls the second camera 107B and the second illumination apparatus 108B based on the ambient light information and the brightness information.

In step S406, the authentication apparatus 10 images the irises of the authentication target by the second camera 107B and generates an iris image.

In step S407, the authentication apparatus 10 transmits the iris image generated in step S406 to the authentication engine 21 and causes the authentication engine 21 to perform the iris authentication. When the authentication engine 21 compares the received iris image with registered iris images of the registrants registered in the registrant information database 23 to perform the iris authentication, the authentication engine 21 transmits an authentication result to the authentication apparatus 10. Thereafter, the processing transitions to step S110.

As described above, with the authentication system 1 according to the fourth example embodiment, unlike the first example embodiment, two-factor authentication of the face recognition and the iris authentication can be realized. In addition, the first illumination apparatus 108A and the second illumination apparatus 108B are controlled when imaging the face of the authentication target and when imaging the irises, respectively. Since the illumination light can be appropriately switched according to the type of the biometric authentication to be performed, biometric images compatible with the face recognition and the iris authentication, respectively, can be obtained.

### Fifth Example Embodiment

Hereinafter, the authentication system 1 according a to fifth example embodiment will be described. Hereinafter, a description will be mainly given of differences from the first example embodiment, and a description will be omitted or simplified for common parts.

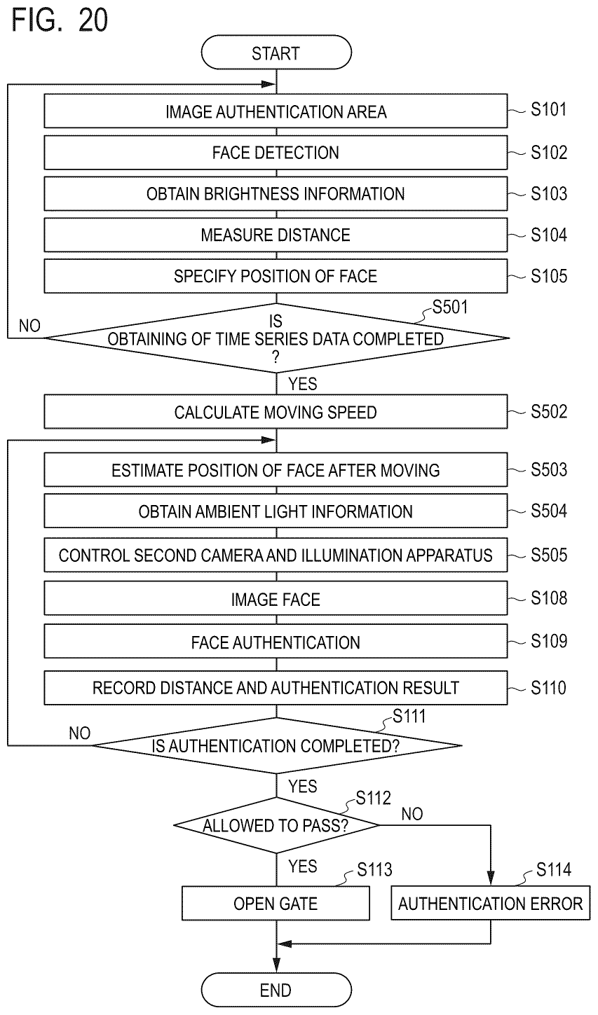

FIG. 20 is a flowchart illustrating the overview of processing performed in an authentication apparatus according to the fifth example embodiment. In FIG. 20, although the processing in steps S101 to S105 and steps S108 to S114 is similar to that of the first example embodiment, processing in step S501 to step S505 is different from that of the first example embodiment.

When the processing in step S105 is completed, the processing transitions to step S501. In step S501, the authentication apparatus 10 determines whether or not obtaining of the time series data regarding the distance and the position of the face is completed.

Here, when the authentication apparatus 10 determines that the obtaining of the time series data is completed (step S501: YES), the processing transitions to step S502. On the other hand, when the authentication apparatus 10 determines that the obtaining of the time series data is not completed (step S501: NO), the processing returns to step S101.

In step S502, the authentication device 10 calculates the moving speed of the authentication subject based on the time series data.

In step S503, the authentication apparatus 10 estimates the position of the face and the distance from the authentication apparatus 10 after movement, based on the moving velocity calculated in step S502. The position of the face means the position coordinates in the three-dimensional space.

In step S504, the authentication apparatus 10 obtains the ambient light information from the ambient light information database 22 based on the estimated distance after the movement.

In step S505, the authentication apparatus 10 controls the second camera 107B and the illumination apparatuses 108 based on the ambient light information and the brightness information. Then, the processing transitions to step S108.

As described above, with the authentication system 1 according to the fifth example embodiment, the ambient light information at a point after the movement can be obtained based on the estimated moving speed of the authentication target. Accordingly, since the second camera 107B and the illumination apparatuses 108 can be appropriately adjusted, the quality of a biometric image to be obtained can be further improved.

### Sixth Example Embodiment

Hereinafter, the authentication system 1 according to a sixth example embodiment will be described. Hereinafter, a description will be mainly given of differences from the first example embodiment, and a description will be omitted or simplified for common parts.

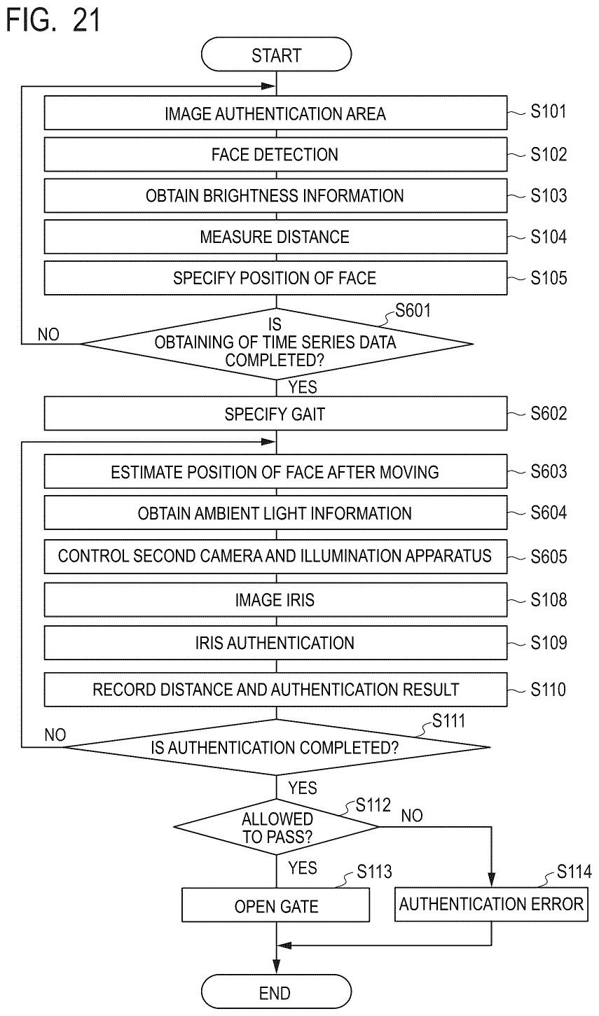

FIG. 21 is a flowchart illustrating the overview of processing performed in an authentication apparatus according to the sixth example embodiment. In FIG. 21, although the processing in steps S101 to S105 and steps S108 to S114 is similar to that of the first example embodiment, processing in step S601 to step S605 is different from that of the first example embodiment.

When the processing in step S105 is completed, the processing transitions to step S601. In step S601, the authentication apparatus 10 determines whether or not obtaining of the time series data regarding the distance and the position of the face is completed.

Here, when the authentication apparatus 10 determines that the obtaining of the time series is completed (step S601: YES), the processing transitions to step S602. On the other hand, when the authentication apparatus 10 determines that the obtaining of the time series data is not completed (step S601: NO), the processing returns to step S101.

In step S602, the authentication apparatus 10 specifies the gait of the authentication target based on the time series data. The gait is the walking pattern of a person. The gait is different for each person in arm swing, difference in stride length, difference in posture, left-right asymmetry of movement, and the like.

In step S603, the authentication apparatus 10 estimates each of the position of the face and the distance from the authentication apparatus 10 after the movement, based on the gait of the authentication target specified in step S602. That is, the authentication apparatus 10 estimates a point at which the authentication target who is moving in the authentication area is located at the timing when the next biometric image is imaged.

In step S604, the authentication apparatus 10 obtains the ambient light information from the ambient light information database 22 based on the estimated distance after the movement.

In step S605, the authentication apparatus 10 controls the second camera 107B and the illumination apparatuses 108 based on the ambient light information and the brightness information. Thereafter, the processing transitions to step S108.

As described above, with the authentication system 1 according to the sixth example embodiment, the ambient light information can be obtained based on the gait of the authentication target. Accordingly, since the second camera 107B and the illumination apparatuses 108 can be appropriately adjusted, the quality of a biometric image to be obtained can be further improved.

### Seventh Example Embodiment

Hereinafter, the authentication system 1 according to a seventh example embodiment will be described. Hereinafter, a description will be mainly given of differences from the first example embodiment, and a description will be omitted or simplified for common parts.

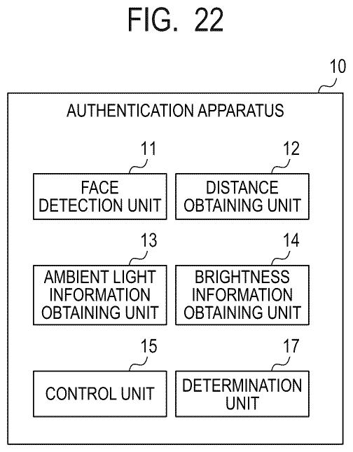

FIG. 22 is a functional block diagram illustrating the general configuration of the authentication apparatus 10 according to the seventh example embodiment. In FIG. 22, the authentication apparatus 10 includes a determination unit 17, in addition to the face detection unit 11, the distance obtaining unit 12, the ambient light information obtaining unit 13, the brightness information obtaining unit 14, and the control unit 15.

The determination unit 17 analyzes an imaged image imaged by the first camera 107A and determines whether or not an article (hereinafter referred to as a worn item) worn by the authentication target affects a biometric image. Specifically, the determination unit 17 determines whether or not the worn item is present in the imaged image, the type of the worn item, the size of the worn item, the transmission state of the illumination light (infrared light) or the ambient light at the worn item, the reflection condition of the illumination light or the ambient light, whether or not a shadow of the worn item is present, and the like.

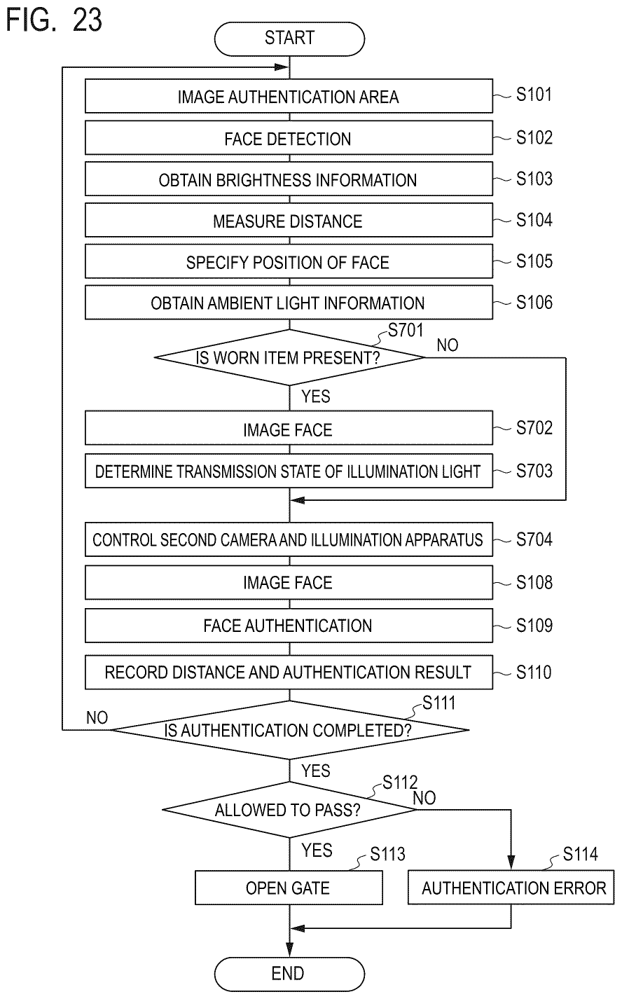

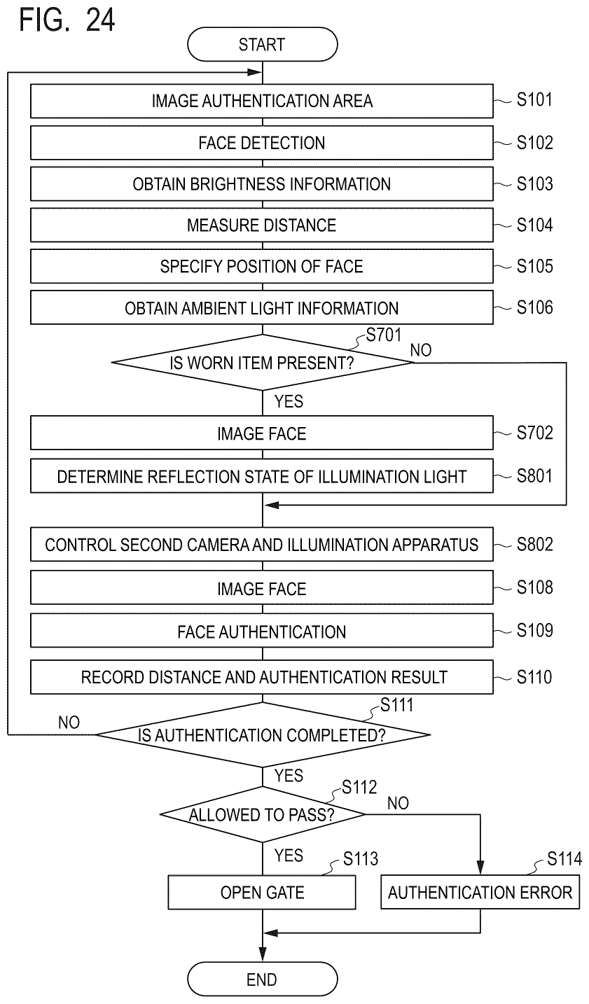

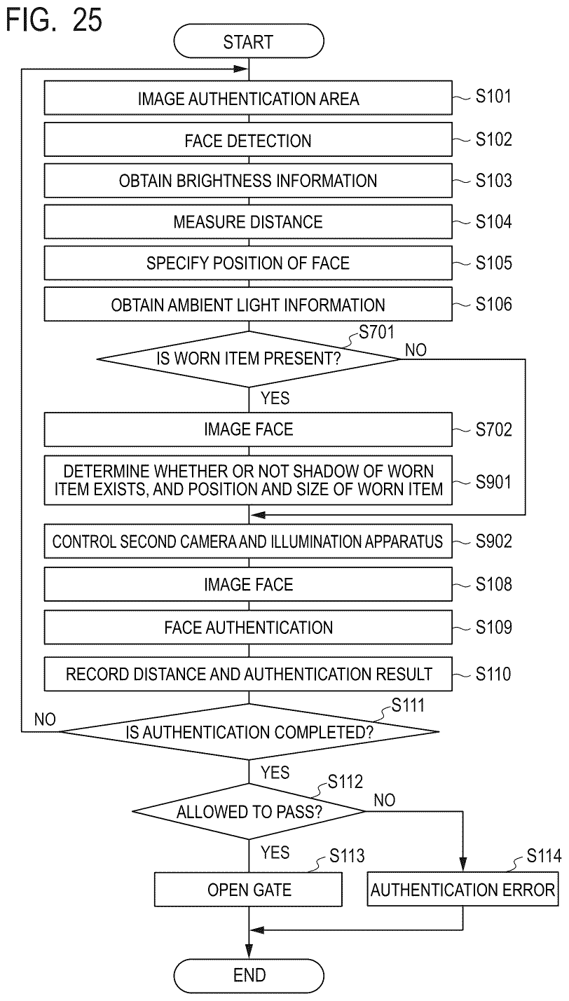

FIG. 23, FIG. 24, and FIG. 25 are flowcharts illustrating the overview of processing performed in the authentication apparatus according to the seventh example embodiment.

FIG. 23 illustrates processing in a case of controlling the second camera 107B and the illumination apparatuses 108 according to the transmission state of the illumination light at the worn item worn by the authentication target. In FIG. 23, although the processing in steps S101 to S106 and steps S108 to S114 is similar to that of the first example embodiment, processing in step S701 to step S704 is different from the first example embodiment.

When the processing in step S106 is completed, the processing transitions to step S701. In step S701, the authentication apparatus 10 analyzes the imaged image, and determines whether or not the worn item on the head of the authentication target is present.

Here, when the authentication apparatus 10 determines that the worn item on the head of the authentication target is present (step S701: YES), the processing transitions to step S702. On the other hand, when the authentication apparatus 10 determines that the worn item on the head of the authentication target is not present (step S701: NO), the processing transitions to step S704.

In step S702, the authentication apparatus 10 images the face of the authentication target together with the worn item. As the worn item, a hat, glasses, sunglasses, a helmet, or the like can be listed.

In step S703, the authentication apparatus 10 analyzes the face image imaged in step S702 and determines the transmission state of the illumination light (infrared light) at the worn item. For example, when the worn item is glasses or sunglasses, the transmission state of the infrared light can be determined from the pixel value in a lens portion.

In step S704, the authentication apparatus 10 controls the second camera 107B and the illumination apparatuses 108 based on a determination result of the transmission state of the illumination light (infrared light) in step S703. For example, when it is determined that the worn item is sunglasses that include black lenses, and do not transmit infrared light of a predetermined wavelength, it is preferable for the authentication apparatus 10 to change the wavelength range of the infrared light irradiated from the illumination apparatus 108. In addition, the reception wavelength range in the second camera 107B may be changed. By considering the transmission state of the illumination light, a high quality biometric image compatible with the biometric authentication can be obtained.

FIG. 24 illustrates processing in a case of controlling the second camera 107B and the illumination apparatuses 108 according to the reflection condition of the illumination light at the worn item. The processing in FIG. 24 is different from that in FIG. 23 in steps S801 and S802.

When the processing in step S702 is completed, the processing transitions to step S801. In step S801, the authentication apparatus 10 analyzes the face image imaged in step S702 and determines the reflection condition of the illumination light on a surface of the worn item.

In step S802, the authentication apparatus 10 controls the second camera 107B and the illumination apparatuses 108 based on a determination result of the reflection condition of the illumination light in step S801. For example, when the worn item is glasses and is reflecting the illumination light, it is preferable for the authentication apparatus 10 to perform control so as to change the imaging angle of the second camera 107B. In addition, the authentication apparatus 10 may change the illuminance and irradiation angle of the illumination light irradiated from the illumination apparatus 108. By considering the reflection condition of the infrared light, a biometric image can be more appropriately obtained.

FIG. 25 illustrates processing in a case of controlling the second camera 107B and the illumination apparatuses 108 according to whether or not a shadow of the worn item is present. The processing in FIG. 25 is different from that in FIG. 23 in steps S901 and S902.

When the processing in step S702 is completed, the processing transitions to step S901. In step S901, the authentication apparatus 10 analyzes the imaged image, and determines whether or not the shadow of the worn item is present on a body part of the authentication target, and the position and size of the shadow.

In step S902, the authentication apparatus 10 controls the second camera 107B and the illumination apparatuses 108 based on the information regarding the shadow of the worn item. For example, when the worn item is a hat, and the shadow of the hat is overlapped with an area of the face of the authentication target in the image, it is preferable for the authentication apparatus 10 to perform control so as to change the imaging angle of the second camera 107B. In addition, the authentication apparatus 10 change may the illuminance and irradiation angle of the infrared light irradiated from the illumination apparatus 108. By considering the information regarding the shadow of the worn item, a biometric image can be more appropriately obtained.

### Eighth Example Embodiment

Hereinafter, the authentication system 1 according to an eighth example embodiment will be described. Hereinafter, a description will be mainly given of differences from the first example embodiment, and a description will be omitted or simplified for common parts.

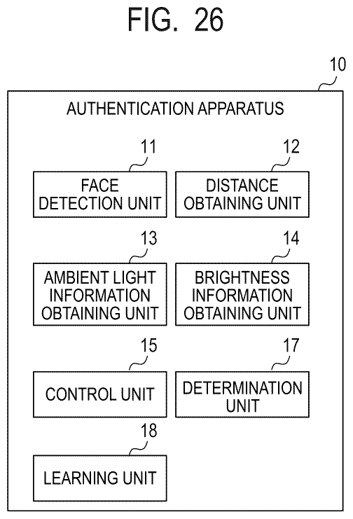

FIG. 26 is a functional block diagram illustrating the general configuration of the authentication apparatus 10 according to the eighth example embodiment. The authentication apparatus 10 includes a learning unit 18, in addition to the face detection unit 11, the distance obtaining unit 12, the ambient light information obtaining unit 13, the brightness information obtaining unit 14, the control unit 15, and the determination unit 17.

The learning unit 18 generates a learning model that outputs control information for the second camera 107B and the illumination apparatuses 108 by using, as an input, the relationship among whether or not an article worn by the authentication target is present in the imaged image, whether or not the shadow is present on the body part of the authentication target, and the size of the shadow. Since the learning model is generated from these items of learning data, a high quality biometric image compatible with the biometric authentication can be obtained. Note that the data used for learning processing is not limited to these items. The data to be input may be data regarding elements that vary the brightness information of the imaged image. For example, displacement data of the imaging angle of the second camera 107B at the time of imaging of the face, and displacement of data the positional relationship between the authentication apparatus 10 (the second camera 107B and the illumination apparatuses 108) and the authentication target at the time of imaging may be included as input data. When learning the displacement data of the imaging angle and the brightness information, it is possible to suppress deterioration in the quality of a biometric image due to sudden displacement in the imaging angle. Similarly, when learning the displacement data of the positional relationship and the brightness information, it is possible to suppress deterioration in the quality of a biometric image due to displacement in the positional relationship.

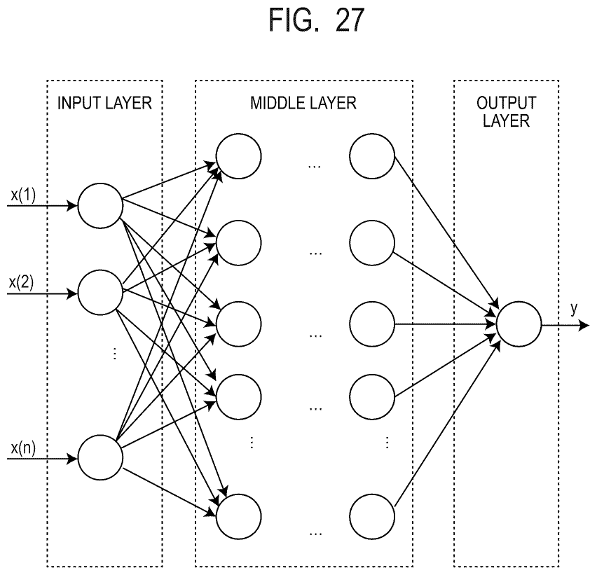

FIG. 27 is a schematic diagram for describing a neural network used for learning processing according to the eighth example embodiment. The neural network illustrated in FIG. 27 includes an input layer including a plurality of nodes, a middle layer including a plurality of nodes, and an output layer including one node. A plurality of types of biological information, which are input values, are input to the respective nodes of the input layer. Each node of the middle layer is connected to each node of the input layer. Each element of the input value that is input to the nodes of the middle layer is used for arithmetic operations in each node of the middle layer. Each node of the middle layer calculates an operation value by using, for example, the input value that is input from each node of the input layer, a predetermined weighting factor, and a predetermined bias value. Each node of the middle layer is connected to the output layer, respectively, and outputs the calculated operation value to the node of the output layer. The operation value is input to the node of the output layer from each node of the middle layer.

The node of the output layer outputs a value indicating optimum control information y by using the operation value that is input from each node of the middle layer, a weighting factor, and a bias value. As an example of the control information y for the second camera 107B, an exposing condition, a gain, the timing of imaging, the imaging angle, or the like can be listed. In addition, as an example of the control information y for the illumination apparatus 108, the illuminance, the wavelength, the irradiation direction, the timing of irradiation, or the like of the illumination light can be listed.

In addition, when causing the neural network to perform learning, for example, the error backpropagation method is used. Specifically, an output value in a case where data is input to the input layer is compared with an output value obtained from training data, and the error between the two compared output values is fed back to the middle layer. This is repeated until the error becomes less than a predetermined threshold value. With such learning processing, the learning model is generated that can output the optimum control information y when data regarding the worn item of the authentication target is input.

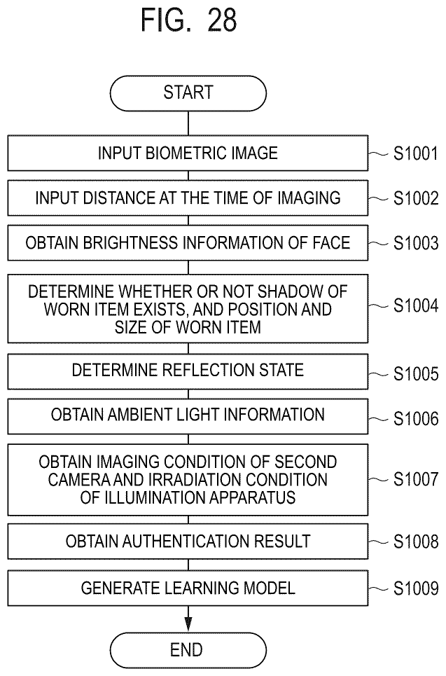

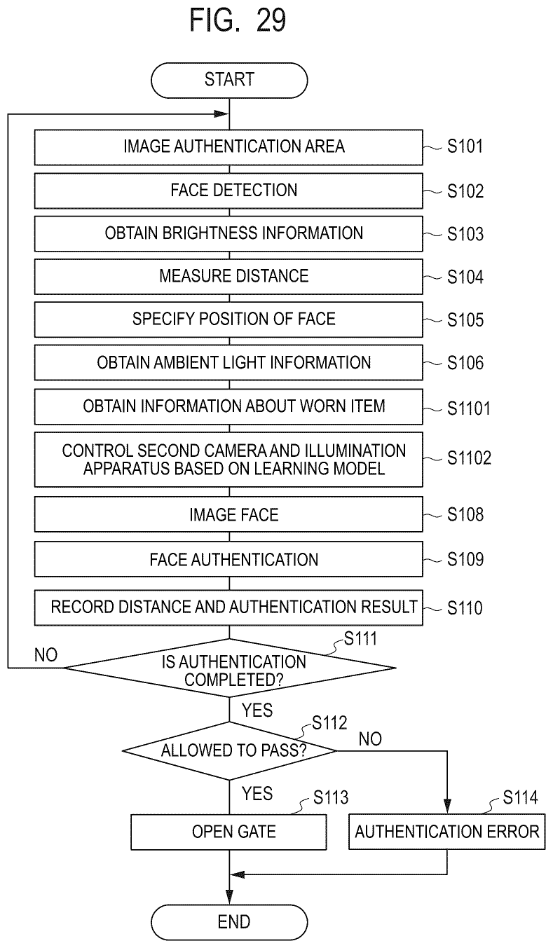

FIG. 28 and FIG. 29 are flowcharts illustrating the overview of processing performed in the authentication apparatus 10 according to the eighth example embodiment.

FIG. 28 illustrates an example of the learning processing in the learning unit 18. This processing may be performed independently from processing of FIG. 29, which will be described later.

In step S1001, the authentication apparatus 10 inputs a biometric image (face image) of the authentication target.

In step S1002, the authentication apparatus 10 obtains the distance from the authentication apparatus 10 to the authentication target at the time of imaging of the biometric image.

In step S1003, the authentication apparatus 10 analyzes the biometric image, and obtains the brightness information of the face of the authentication target.

In step S1004, the authentication apparatus 10 analyzes the biometric image, and determines whether or not the shadow of the worn item is present on the face area of the authentication target, the position of the shadow, and the size of the shadow.

In step S1005, the authentication apparatus 10 analyzes the biometric image, and determines the reflection condition of the illumination light at the worn item.

In step S1006, the authentication apparatus 10 obtains the ambient light information from the ambient light information database 22 based on the distance.

In step S1007, the authentication apparatus 10 obtains the imaging condition of the second camera 107B determined before imaging the face, and the irradiation condition of the illumination light in the illumination apparatus 108.

In step S1008, the authentication apparatus 10 obtains an authentication result of the face recognition based on the face image imaged under the conditions in step S1007.

In step S1009, the authentication apparatus 10 generates a learning model based on the brightness information, the ambient light information, the distance, the information regarding the worn item, the reflection condition of the illumination light, the control information, and the authentication result.

FIG. 29 illustrates an example of processing for controlling the second camera 107B and the illumination apparatuses 108 based on the learning model generated by the learning processing illustrated in FIG. 28. In FIG. 29, although the processing in steps S101 to S106 and steps S108 to S114 is similar to that of the first example embodiment, processing in step S1101 to step S1102 is different from that of the first example embodiment.

When the processing in step S106 is completed, the processing transitions to step S1101. In step S1101, the authentication apparatus 10 analyzes a face image of the authentication target extracted from the imaged image and obtains the information regarding the worn item.

In step S1102, the authentication apparatus 10 inputs the brightness information, the ambient light information, the distance, the information regarding the worn item, the reflection condition of the illumination light, the control information, and the authentication result to the learning model, and outputs the control information that is output from the learning model. The authentication apparatus 10 controls the second camera 107B and the illumination apparatuses 108 based on the control information that is output from the learning model. Thereafter, the processing transitions to step S108.

As described above, with the authentication system 1 according to the eighth embodiment, a biometric image suitable for biometric authentication can be obtained by controlling the second camera 107B and the illumination apparatuses 108, based on the learning model that has learned the relationship between the information regarding the worn item and the factor of the worn item that affects the illuminance of the ambient light. In addition, a learning model may be generated so that one of two influences, i.e., the influence due to occurrence of the shadow and the influence due to reflection, is reduced with priority over the other, based on the accuracy of the biometric authentication. Accordingly, a high quality biometric image compatible with the biometric authentication can be obtained.

### Ninth Example Embodiment

Hereinafter, the authentication system 1 according to a ninth embodiment will be described. Hereinafter, a description will be mainly given of differences from the first example embodiment, and a description will be omitted or simplified for common parts.

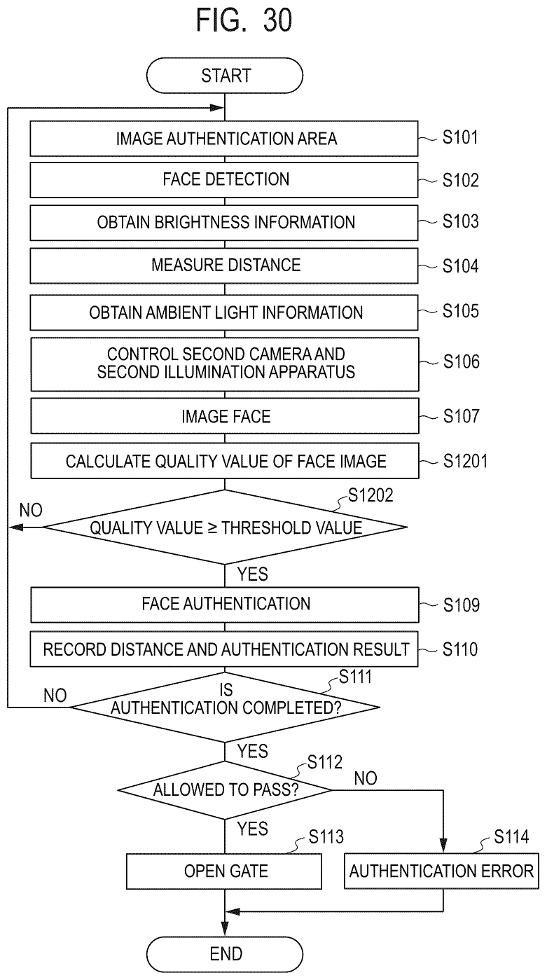

FIG. 30 is a flowchart illustrating the overview of processing performed in the authentication apparatus 10 according to the ninth example embodiment. In FIG. 30, although the processing in steps S101 to S107 and steps S109 to S114 is similar to that of the first example embodiment, processing in step S1201 to step S1202 is different from that of the first example embodiment.

When the processing in step S107 is completed, the processing transitions to step S1201. In step S1201, the authentication apparatus 10 calculates a quality value of the face image generated in step S107. For example, the authentication apparatus 10 can calculate the quality value of the face image by comparing the brightness information of the obtained face image with the brightness information (registered brightness information) of registered face images that have been confirmed in advance to be compatible with the face recognition. In this case, the quality value of the biometric image can be easily calculated. In addition, the authentication apparatus 10 may calculate the quality value of the face image based on the pixel value of the generated face image. The calculating method of the quality value can be arbitrarily determined. The authentication apparatus 10 may correct the quality value based on, for example, the displacement amount of the illuminance of the illumination light per unit time. In this case, it is possible to suppress deterioration in the quality of a biometric image due to sudden displacement in the illuminance of the illumination light.

In step S1202, the authentication apparatus 10 determines whether or not the calculated quality value is equal to or more than a predetermined threshold value.

Here, when the authentication apparatus 10 determines that the quality value is equal to or more than the predetermined threshold value (step S1202: YES), the processing transitions to step S109. Then, the face recognition is performed (step S109). On the other hand, when the authentication apparatus 10 determines that the quality value is less than the threshold value (step S1202: NO), the processing returns to step S101.

As described above, with the authentication system 1 according to the ninth embodiment, it is possible to perform control such that the biometric authentication is performed when the quality value of the generated biometric image satisfies a predetermined condition, and the biometric authentication is not performed when the quality value does not satisfy the predetermined condition. Since it is possible to avoid performing unnecessary biometric authentication, and to quickly transition to the next imaging processing, it is possible to increase the number of times of performing the biometric authentication based on a high quality biometric image.

### Tenth Example Embodiment

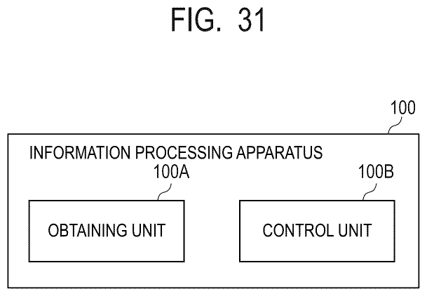

FIG. 31 is a functional block diagram illustrating the general configuration of an information processing apparatus 100 according to a tenth example embodiment. The information processing apparatus 100 includes an obtaining unit 100A and a control unit 100B. The obtaining unit 100A obtains the positional relationship between the target of the biometric authentication and an imaging apparatus that images the target, the ambient light information including at least one of illumination light irradiated to the target by the illumination apparatus and the ambient light around the target, and the brightness information of the target in the imaged image imaged by the imaging apparatus. The control unit 100B controls at least one of the illumination apparatus and the imaging apparatus based on the positional relationship, the ambient light information, and the brightness information. According to the tenth example embodiment, the information processing apparatus 100 that can obtain a biometric image suitable for the biometric authentication is provided.

### Eleventh Example Embodiment

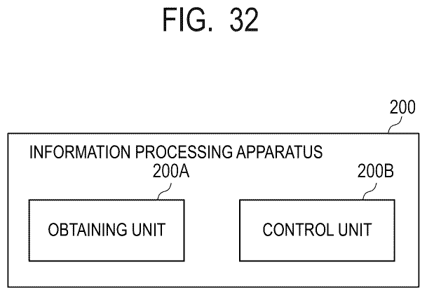

FIG. 32 is a functional block diagram illustrating the general configuration of an information processing apparatus 200 according to an eleventh example embodiment. The information processing apparatus 200 includes an obtaining unit 200A and a control unit 200B. The obtaining unit 200A obtains the ambient light information representing the factor that may affect the illuminance at target 41 the of the biometric authentication. The control unit 200B controls at least one of the illumination apparatus that irradiates the target with the illumination light and the imaging apparatus that images the target, based on the ambient light information. According to the eleventh example embodiment, the information processing apparatus 200 that can obtain a biometric image suitable for the biometric authentication is provided.

### Variant Example Embodiment

This disclosure is not limited to the above-described embodiments and can be appropriately changed within a range that does not depart from the spirit of this disclosure. For example, an example in which a part of the configuration of one of the embodiments is added to another embodiment, and an example in which the part of the configuration of the one of the embodiments is replaced with a part of the configuration of another embodiment are also embodiments of this disclosure.

In the above-described embodiments, although the case has been described where the face recognition is performed in the authentication system 1, the technique of this disclosure can also be applied to a system that performs iris authentication. When the authentication system 1 is an iris authentication system, the second camera 107B may be changed to an iris camera. An iris image to be used for the iris authentication can be obtained by irradiating infrared light to the eyes of a person from the illumination apparatuses 108, and imaging the infrared light reflected by the irises with the iris camera.

In the above-described embodiments, although the configuration has been described that measures the distance from the authentication apparatus 10 to the authentication target based on the detection signal from the distance sensor 109, the measuring method of the distance is not limited to this. For example, the actual distance from the authentication apparatus 10 to the authentication target may be estimated based on the distance between the eyes of the authentication target in the imaged image. In this case, the distance sensor 109 can be omitted, and the manufacturing cost can be reduced.

In addition, in the above-described embodiments, although the case has been described in which both the illumination apparatuses 108 and the second camera 107B are controlled, at least one of the illumination apparatuses 108 and the second cameras 107B may be controlled. That is, only one of the illumination apparatuses 108 and the second camera 107B may be controlled.

In addition, the authentication apparatus 10 may control at least one of the illumination apparatuses 108 and the second cameras 107B, based on a change in each of the positional relationship in the biometric authentication that has already been performed, the illuminance of the illumination light irradiated by the illumination apparatus, and the brightness information. For example, when the biometric authentication for a first person fails since the illumination light is too dark at a three-meter point, it becomes possible to perform control so as to make the illumination light irradiated to the next second person brighter at the three-meter point in the biometric authentication for the second person. Accordingly, a quality high compatible with the biometric biometric image authentication can be obtained.

In addition, the authentication apparatus 10 may control at least one of the illumination apparatuses 108 and the second cameras 107B, based on a change in each of a comparison score (authentication result) in the biometric authentication that has already been performed and the positional relationship. Specifically, the comparison score and the displacement data of the distance to be authenticated that has been previously performed for the first person can be recorded, and when imaging a biometric image for the biometric authentication for a second person after the first person, the illumination apparatuses 108 and the second camera 107B can be controlled based on the comparison score and the displacement data of the distance for the first person. In addition, when the comparison score for the first person in the biometric authentication based on the biometric image imaged at a point that is two meters away from the authentication apparatus 10 is high, a control parameter of the illumination apparatuses 108 at the point can be corrected also for the next second person, while considering the point as a best point. Accordingly, a high quality biometric image compatible with the biometric authentication can be obtained.

In the above-described embodiment, although the imaging angle and the imaging range are changed by driving the second camera 107B itself, the configuration for changing the imaging angle and the imaging range is not limited to this. For example, a configuration using a rotating mirror may be applied.

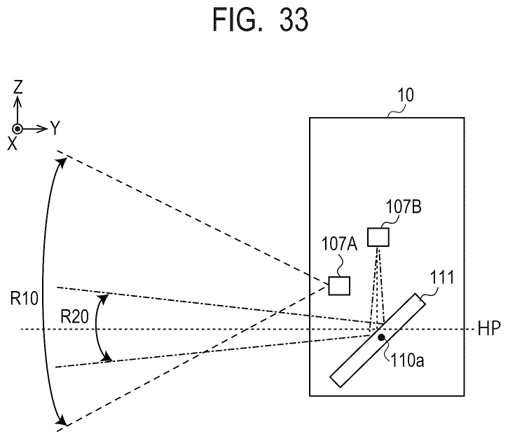

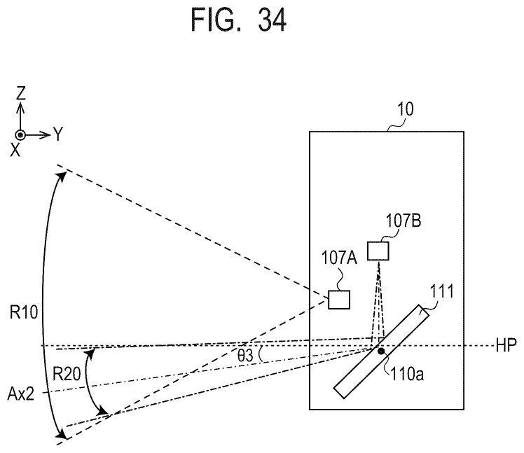

FIG. 33 and FIG. 34 are schematic diagrams for describing a changing method of the imaging angle and the imaging range of the authentication apparatus 10 according to a variant example embodiment. A rotating mirror 111 is a member that is provided to be driven in the vertical direction with respect to horizontal and reflects light entering from the outside of the authentication apparatus 10 toward the second camera 107B. As illustrated in FIG. 33 and FIG. 34, the first camera 107A is horizontally arranged.

On the other hand, a receiving surface of the second camera 107B is arranged vertically downward so as to face a reflective surface of the rotating mirror 111. The rotating mirror 111 is connected to a rotation axis 110a of the motor 110 and can be rotated with the rotation axis 110a. FIG. 33 illustrates a state before the rotating mirror 111 is driven. On the other hand, FIG. 34 illustrates a state where the rotating mirror 111 is rotated counterclockwise from the state in FIG. 33. The optical axis Ax of the second camera 107B intersects with a horizontal plane HP at an angle of −θ3. That is, the imaging angle of the second camera 107B in FIG. 34 is −θ3.

In addition, an imaging range R10 of the first camera 107A is wider than an imaging range R20 of the second camera 107B. That is, the angle of view of the first camera 107A is larger than the angle of view of the second camera 107B. The authentication apparatus 10 moves the imaging range R20 of the second camera 107B by changing the inclination angle of the rotating mirror 111 by using the motor 110. For example, the authentication apparatus 10 can move the imaging range R20 of the second camera 107B up and down along the vertical direction by rotating the rotating mirror 111.

With the authentication system 1 according to the variant example embodiment, it is unnecessary to drive the second camera 107B itself in order to change the imaging angle of the second camera 107B. By driving the rotating mirror 111 instead of the second camera 107B, a biometric image to be used for the biometric authentication can be imaged at an appropriate imaging angle. Note that the rotating mirror 111 may not be directly connected to the rotation axis 110a of the motor 110. For example, the rotating mirror 111 may be indirectly connected to the rotation axis 110a via a gear, a belt, or the like, and driven by the motor 110.

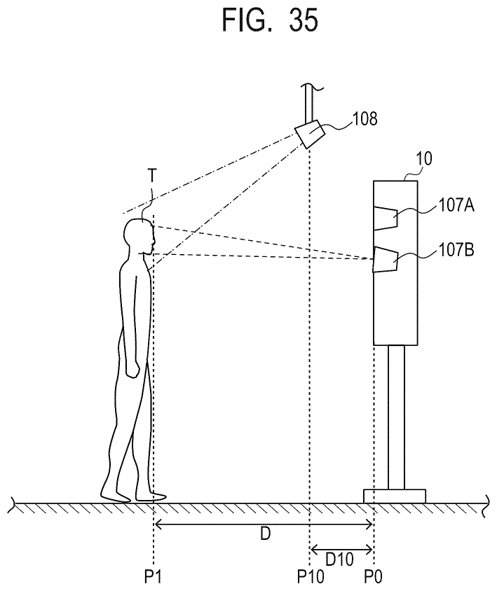

In the above-described first embodiments, the description has been given of the authentication apparatus 10 in which the imaging apparatus (the first camera 107A and the second camera 107B) and the illumination apparatuses 108 are integrated. However, the imaging apparatus and the illumination apparatuses 108 may be provided independently from each other. FIG. 35 is a diagram illustrating an example of the positional relationship among the imaging apparatus, the illumination apparatus 108, and the authentication target T in the variant example embodiment. Here, the illumination apparatus 108 is installed at a point P10 that is separated by a distance D10 from a point P0 at which the authentication apparatus 10 is installed. In FIG. 35, although the illumination apparatus 108 is suspended from a ceiling part (not illustrated), the installation method of the illumination apparatus 108 is not limited to this. In addition, the positional relationship among the illumination apparatus 108, the imaging apparatus, and the authentication target T is not limited to the positional relationship illustrated in FIG. 35. For example, the illumination apparatus 108 may be provided at a position more distant from the authentication target T than the imaging apparatus. In addition, the illumination apparatus 108 may be installed above or below the imaging apparatus. When the imaging apparatus and the illumination apparatus 108 are provided at a distance, the authentication system may store, in a database, the positional relationship among the imaging apparatus, the illumination apparatus 108, and the authentication target T in association with the ambient light information. By determining an imaging condition based on the ambient light information associated with the positional relationship, the brightness of a biometric image imaged by the imaging apparatus can be maintained within a predetermined range compatible with the biometric authentication. Then, by performing the biometric authentication using the biometric image imaged with appropriate brightness, the authentication accuracy in the biometric authentication can be improved.

A processing method that causes a storage medium to record a program for operating the configurations of the above-described embodiments so as to realize the functions of the embodiments, reads the program recorded on the storage medium as a code, and executes the code in a computer is also included in the category of each of the embodiments. That is, a computer-readable storage medium is also included in the scope of each of the embodiments. In addition, not only the storage medium on which the above-described program is recorded, but the program itself is also included in each of the embodiments. In addition, one or two or more components included in the above-described embodiments may be circuits, such as an ASIC and an FPGA, which are configured to realize the functions of the respective components.

s the storage medium, for example, a floppy (registered trademark) disk, a hard disk, an optical disc, a magneto-optical disc, a CD (Compact Disk)-ROM, a magnetic tape, a nonvolatile memory card, or a ROM can be used. In addition, not only performing processing by the single program recorded on the storage medium, but also performing processing while being operated on an OS (Operating System) in cooperation with the functions of another software and an expansion board is included the category of each of the embodiments.

The services realized by the functions of each of the above-described embodiments can also be provided to a user in the form of Saas (Software as a Service).

Note that the above-described embodiments merely illustrate specific examples for implementing this disclosure, and the technical scope of this disclosure shall not be restrictively interpreted by these embodiments. That is, this disclosure can be implemented in various forms, without departing from the technical idea thereof or the main features thereof.

The whole or part of the example embodiments disclosed above can be described as, but not limited to, the following supplementary notes.

### Supplementary Note 1

An information processing apparatus comprising:
an obtaining unit that obtains a positional relationship between a target of biometric authentication and an imaging apparatus that images the target, ambient light information including at least one of illumination light irradiated to the target by an illumination apparatus and ambient light around the target, and brightness information at the target in an imaged image imaged by the imaging apparatus; and

a control unit that controls at least one of the illumination apparatus and the imaging apparatus, based on the positional relationship, the ambient light information, and the brightness information.

### Supplementary Note 2

The information processing apparatus according to supplementary note 1,
wherein the ambient light information is associated in advance with the positional relationship, and
wherein the control unit updates the ambient light information based on an imaging condition of the imaged image, and a result of the biometric authentication performed based on the imaged image.

### Supplementary Note 3

The information processing apparatus according to supplementary note 1,
wherein the control unit controls at least one of the illumination apparatus and the imaging apparatus based on an imaging condition of the imaged image, the positional relationship at a time of imaging, and a result of the biometric authentication performed based on the imaged image.

### Supplementary Note 4

The information processing apparatus according to any one of supplementary notes 1 to 3,
wherein the control unit turns on the illumination apparatus among a plurality of the illumination apparatuses that corresponds to a type of the biometric authentication performed in the positional relationship.

### Supplementary Note 5

The information processing apparatus according to any one of supplementary notes 1 to 3,
wherein the control unit controls at least one of the illumination apparatus and the imaging apparatus based on a color of a body part of the target indicated by the brightness information.

### Supplementary Note 6

The information processing apparatus according to any one of supplementary notes 1 to 4,
wherein the control unit controls at least one of the illumination apparatus and the imaging apparatus based on at least one of a position of a face of the target in a three-dimensional space specified from the imaged image, moving speed of the target specified from the positional relationship, and a gait of the target specified from the positional relationship.

### Supplementary Note 7

The information processing apparatus according to any one of supplementary notes 1 to 6, further comprising:
a determination unit that determines, based on the imaged image, a transmission state of the illumination light at an article worn by the target,
wherein the control unit controls at least one of an irradiation wavelength range of the illumination light of the illumination apparatus and a reception wavelength range in the imaging apparatus, based on a determination result of the transmission state.

### Supplementary Note 8

The information processing apparatus according to any one of supplementary notes 1 to 6, further comprising:
a determination unit that determines, based on the imaged image, a reflection state of the illumination light at an article worn by the target,
wherein the control unit controls at least one of the illumination apparatus and the imaging apparatus based on the reflection state.

### Supplementary Note 9

The information processing apparatus according to any one of supplementary notes 1 to 6, further comprising:
a determination unit that determines, based on the imaged image, each of whether or not an article worn by the target is present, and whether or not a shadow of the article is present on a body part of the target; and
a learning unit that learns a relationship among whether or not the article is present, the positional relationship, and whether or not the shadow is present, wherein the control unit controls at least one of the illumination apparatus and the imaging apparatus based on a learned result in the learning unit.

### Supplementary note 10

The information processing apparatus according to any one of supplementary notes 1 to 6, further comprising:
a determination unit that determines, based on the imaged image, each of whether or not an article worn by the target is present, reflection state of the illumination light at the article, and whether or not a shadow of the article is present on a body part of the target; and
a learning unit that learns whether or not the article is present, the positional relationship, the reflection state, and whether or not the shadow is present,
wherein the control unit controls, based on a learned result of the learning unit, at least one of the illumination apparatus and the imaging apparatus so that reflection is eliminated.

### Supplementary Note 11

The information processing apparatus according to any one of supplementary notes 1 to 6, further comprising:
a learning unit that learns a relationship among displacement in an imaging angle of the imaging apparatus, displacement in the brightness information, whether or not an article worn by the target is present, whether or not a shadow of the article is present on a body part of the target, and a reflection state of the illumination light at the article,
wherein the control unit controls at least one of the illumination apparatus and the imaging apparatus based on a learned result of the learning unit.

### Supplementary note 12

The information processing apparatus according to any one of supplementary notes 1 to 11,
wherein the control unit calculates a quality value of the imaged image based on a comparison result between the brightness information and predetermined registered brightness information, and requests an authentication apparatus to perform the biometric authentication based on the quality value.

### Supplementary Note 13

The information processing apparatus according to any one of supplementary notes 1 to 11,
wherein the control unit corrects a quality value of the imaged image based on a displacement amount of illuminance of the illumination light per unit time, and requests an authentication apparatus to perform the biometric authentication based on the quality value.

### Supplementary Note 14

The information processing apparatus according to any one of supplementary notes 1 to 13,
wherein the control unit controls at least one of the illumination apparatus and the imaging apparatus, based on a change in the positional relationship in the biometric authentication that has already been performed, illuminance of the illumination light irradiated by the illumination apparatus, and the brightness information.

### Supplementary Note 15

The information processing apparatus according to any one of supplementary notes 1 to 13,
wherein the control unit controls at least one of the illumination apparatus and the imaging apparatus, based on a change in each of a comparison score in the biometric authentication that has already been performed and the positional relationship.

### Supplementary Note 16

An information processing method comprising the steps of:
obtaining a positional relationship between a target of biometric authentication and an imaging apparatus that images the target, ambient light information including at least one of illumination light irradiated to the target by an illumination apparatus and ambient light around the target, and brightness information at the target in an imaged image imaged by the imaging apparatus; and
controlling at least one of the illumination apparatus and the imaging apparatus, based on the positional relationship, the ambient light information, and the brightness information.

### Supplementary Note 17

A recording medium recording thereon a program for causing a computer to perform an information processing method comprising the steps of:
obtaining a positional relationship between a target of biometric authentication and an imaging apparatus that images the target, ambient light information including at least one of illumination light irradiated to the target by an illumination apparatus and ambient light around the target, and brightness information at the target in an imaged image imaged by the imaging apparatus; and
controlling least one of the illumination apparatus and the imaging apparatus, based on the positional relationship, the ambient light information, and the brightness information.

### Supplementary Note 18

An information processing apparatus comprising:
an obtaining unit that obtains ambient light information representing a factor that may affect illuminance at a target of biometric authentication; and
a control unit that controls, based on the ambient light information, at least one of an illumination apparatus that irradiates the target with illumination light and an imaging apparatus that images the target.

### Supplementary Note 19

The information processing apparatus according to supplementary note 18,
wherein the ambient light information includes a date and time of imaging.

### Supplementary Note 20

The information processing apparatus according to supplementary note 18 or 19,
wherein the ambient light information includes weather information.

### Supplementary Note 21

The information processing apparatus according to any one of supplementary notes 18 to 20,
wherein the ambient light information includes optical properties, shape, size, and arrangement of a structure around the target.

### Supplementary Note 22

An information processing method comprising the steps of:
obtaining ambient light information representing a factor that may affect illuminance at a target of biometric authentication; and
controlling, based on the ambient light information, at least one of an illumination apparatus that irradiates the target with illumination light and an imaging apparatus that images the target.

### Supplementary Note 23

A recording medium recording thereon a program for performing the steps of:
obtaining ambient light information representing a factor that may affect illuminance at a target of biometric authentication; and
controlling, based on the ambient light information, at least one of an illumination apparatus that irradiates the target with illumination light and an imaging apparatus that images the target.

### REFERENCE SIGNS LIST

1 authentication system
10 authentication apparatus
101 processor
102 RAM
103 ROM
104 storage
105 communication I/F
106 display
107A first camera
107B second camera
108 illumination apparatus
108A first illumination apparatus
108B second illumination apparatus
109 distance sensor
110 motor
111 rotating mirror

120 authentication server
21 authentication engine
22 ambient light information database
23 registrant information database
24 layout information database
30 gate apparatus
100, 200 information processing apparatus
100A obtaining unit
100B control unit
200A obtaining unit
200B control unit

What is claimed is:

1. An information processing apparatus comprising:
an obtaining unit that obtains a positional relationship between a target of biometric authentication and an imaging apparatus that images the target, ambient light information including at least one of illumination light irradiated to the target by an illumination apparatus and ambient light around the target, and brightness information at the target in an imaged image imaged by the imaging apparatus; and
a control unit that controls at least one of the illumination apparatus and the imaging apparatus, based on the positional relationship, the ambient light information, and the brightness information.

2. The information processing apparatus according to claim 1,
wherein the ambient light information is associated in advance with the positional relationship, and
wherein the control unit updates the ambient light information based on an imaging condition of the imaged image, and a result of the biometric authentication performed based on the imaged image.

3. The information processing apparatus according to claim 1,
wherein the control unit controls at least one of the illumination apparatus and the imaging apparatus based on an imaging condition of the imaged image, the positional relationship at a time of imaging, and a result of the biometric authentication performed based on the imaged image.

4. The information processing apparatus according to claim 1,
wherein the control unit turns on the illumination apparatus among a plurality of the illumination apparatuses that corresponds to a type of the biometric authentication performed in the positional relationship.

5. The information processing apparatus according to claim 1,
wherein the control unit controls at least one of the illumination apparatus and the imaging apparatus based on a color of a body part of the target indicated by the brightness information.

6. The information processing apparatus according to claim 1,
wherein the control unit controls at least one of the illumination apparatus and the imaging apparatus based on at least one of a position of a face of the target in a three-dimensional space specified from the imaged image, moving speed of the target specified from the positional relationship, and a gait of the target specified from the positional relationship.

7. The information processing apparatus according to claim 1, further comprising:
a determination unit that determines, based on the imaged image, a transmission state of the illumination light at an article worn by the target,
wherein the control unit controls at least one of an irradiation wavelength range of the illumination light of the illumination apparatus and a reception wavelength range in the imaging apparatus, based on a determination result of the transmission state.

8. The information processing apparatus according to claim 1, further comprising:
a determination unit that determines, based on the imaged image, a reflection state of the illumination light at an article worn by the target,
wherein the control unit controls at least one of the illumination apparatus and the imaging apparatus based on the reflection state.

9. The information processing apparatus according to claim 1, further comprising:
a determination unit that determines, based on the imaged image, each of whether or not an article worn by the target is present, and whether or not a shadow of the article is present on a body part of the target; and
a learning unit that learns a relationship among whether or not the article is present, the positional relationship, and whether or not the shadow is present,
wherein the control unit controls at least one of the illumination apparatus and the imaging apparatus based on a learned result in the learning unit.

10. The information processing apparatus according to claim 1, further comprising:
a determination unit that determines, based on the imaged image, each of whether or not an article worn by the target is present, a reflection state of the illumination light at the article, and whether or not a shadow of the article is present on a body part of the target; and
a learning unit that learns whether or not the article is present, the positional relationship, the reflection state, and whether or not the shadow is present,
wherein the control unit controls, based on a learned result of the learning unit, at least one of the illumination apparatus and the imaging apparatus so that reflection is eliminated.

11. The information processing apparatus according to claim 1, further comprising:
a learning unit that learns a relationship among displacement in an imaging angle of the imaging apparatus, displacement in the brightness information, whether or not an article worn by the target is present, whether or not a shadow of the article is present on a body part of the target, and a reflection state of the illumination light at the article,
wherein the control unit controls at least one of the illumination apparatus and the imaging apparatus based on a learned result of the learning unit.

12. The information processing apparatus according to claim 1,
wherein the control unit calculates a quality value of the imaged image based on a comparison result between the brightness information and predetermined registered brightness information, and requests an authentication apparatus to perform the biometric authentication based on the quality value.

13. The information processing apparatus according to claim 1,
wherein the control unit corrects a quality value of the imaged image based on a displacement amount of illuminance of the illumination light per unit time, and requests an authentication apparatus to perform the biometric authentication based on the quality value.

14. The information processing apparatus according to claim 1,
wherein the control unit controls at least one of the illumination apparatus and the imaging apparatus, based on a change in the positional relationship in the biometric authentication that has already been performed, illuminance of the illumination light irradiated by the illumination apparatus, and the brightness information.

15. The information processing apparatus according to claim 1,
wherein the control unit controls at least one of the illumination apparatus and the imaging apparatus, based on a change in each of a comparison score in the biometric authentication that has already been performed and the positional relationship.

16. An information processing method comprising the steps of:
obtaining a positional relationship between a target of biometric authentication and an imaging apparatus that images the target, ambient light information including at least one of illumination light irradiated to the target by an illumination apparatus and ambient light around the target, and brightness information at the target in an imaged image imaged by the imaging apparatus; and
controlling at least one of the illumination apparatus and the imaging apparatus, based on the positional relationship, the ambient light information, and the brightness information.

17. A recording medium recording thereon a program for causing a computer to perform an information processing method comprising the steps of:
obtaining a positional relationship between a target of biometric authentication and an imaging apparatus that images the target, ambient light information including at least one of illumination light irradiated to the target by an illumination apparatus and ambient light around the target, and brightness information at the target in an imaged image imaged by the imaging apparatus; and
controlling at least one of the illumination apparatus and the imaging apparatus, based on the positional relationship, the ambient light information, and the brightness information.

18.-23. (canceled)
